(19) United States
(12) Patent Application Publication
(10) Pub. No.: US 2021/0175580 A1
(43) Pub. Date: Jun. 10, 2021

(54) ELECTROCHEMICAL DEVICES AND METHODS OF MAKING AND USE THEREOF

(71) Applicant: BOARD OF REGENTS, THE UNIVERSITY OF TEXAS SYSTEM, Austin, TX (US)

(72) Inventors: Charles AMOS, Austin, TX (US); Nicholas GRUNDISH, Austin, TX (US)

(21) Appl. No.: 17/047,775

(22) PCT Filed: Apr. 16, 2019
(86) PCT No.: PCT/US2019/027586

§ 371 Date: Oct. 15, 2020

Related U.S. Application Data
(60) Provisional application No. 62/806,243, filed on Feb. 15, 2019.
(60) Provisional application No. 62/658,051, filed on Apr. 16, 2018.

(51) Int. Cl. H01M 50/446; H01M 4/36; H01M 50/443; H01M 4/58

(52) U.S. Cl. CPC H01M 50/446; H01M 4/5825; H01M 50/443; H01M 4/366

(57) ABSTRACT

Disclosed herein are electrochemical devices and methods of making and use thereof. The electrochemical devices comprise a coated electrode comprising a first electrode and a porous separator layer, wherein the porous separator layer comprises a plurality of electrically insulating particles and a plurality of pores, wherein the porous separator layer is coated on the first electrode; a second electrode; and an electrolyte; wherein the coated electrode is in contact with the second electrode such that the porous separator layer is disposed between the first electrode and the second electrode and the porous separator layer is in contact with the first electrode and the second electrode, thereby forming an electrode assembly; and wherein the electrolyte is in electrochemical contact with the first electrode and the second electrode.

### CROSS-REFERENCE TO RELATED APPLICATIONS

This application claims the benefit of priority to U.S. Provisional Application No. 62/658,051, filed Apr. 16, 2018, and U.S. Provisional Application No. 62/806,243, filed Feb. 15, 2019, which are both hereby incorporated herein by reference in their entireties.

### BACKGROUND

Separators have wide-spread use in electrochemical systems such as Li-ion batteries, fuel cells, and electrolytic cells. Currently, separators are continuous, porous sheets of polymers that are separate components relative to the electrodes within the electrochemical cells. A drawback of such traditional separators is their thickness, which can limit the energy and power density of the electrochemical cell. Accordingly, thinner separators, which can thus increase the energy and power density of electrochemical cells, are needed. The devices and methods discussed herein address these and other needs.

### SUMMARY

In accordance with the purposes of the disclosed devices and methods, as embodied and broadly described herein, the disclosed subject matter relates to electrochemical devices and methods of making and using thereof.

Additional advantages of the disclosed devices and methods will be set forth in part in the description which follows, and in part will be obvious from the description. The advantages of the disclosed devices will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 shows a schematic side view of an electrode assembly for an example electrochemical device.

FIG. 2 shows a schematic top down view of the porous separator layer.

FIG. 3 shows a schematic side view of an electrode assembly for an example electrochemical device.

FIG. 4 shows a schematic side view of an electrode assembly for an example electrochemical device.

FIG. 5 shows a schematic side view of an electrode assembly for an example electrochemical device.

FIG. 6 is a scanning electron microscopy (SEM) image of the surface of an uncoated lithium iron phosphate (LFP) electrode. The surface of the LFP electrode was rough and included non-spherical particles ˜5-20 microns in size.

FIG. 7 is an SEM image of the surface of an uncoated LFP electrode. The surface of the LFP electrode was rough and included non-spherical particles ˜5-20 microns in size.

FIG. 8 is an SEM image of the surface of an uncoated LFP electrode. The surface of the LFP electrode was rough and included non-spherical particles ˜5-20 microns in size.

FIG. 9 is an SEM image of the surface of an uncoated LFP electrode. The surface of the LFP electrode was rough and included non-spherical particles ˜5-20 microns in size.

FIG. 10 is a photograph of two coated electrodes (left) and one uncoated (right) LFP electrodes.

FIG. 11 is an SEM image of an LFP electrode after 5 layers of a mixture of SiO₂ particles dispersed in a mixture of water and ethanol were sequentially spray coated onto the surface of the LFP electrode.

FIG. 12 is an SEM image of the LFP electrode with 5 layers of SiO₂ particles coated thereon.

FIG. 13 is an SEM image of the LFP electrode with 5 layers of SiO₂ particles coated thereon.

FIG. 14 is an SEM image of the LFP electrode with 5 layers of SiO₂ particles coated thereon.

FIG. 15 is an SEM image of the LFP electrode with 5 layers of SiO₂ particles coated thereon. The underlying LFP surface particles, which are non-spherical, are still visible, meaning the thickness of the coating of SiO₂ particles, which are spherical, was insufficient.

FIG. 16 is an SEM image of the LFP electrode with 5 layers of SiO₂ particles coated thereon. The underlying LFP surface particles, which are non-spherical, are still visible, meaning the thickness of the coating of SiO₂ particles, which are spherical, was insufficient.

FIG. 17 is an SEM image of the LFP electrode with 5 layers of SiO₂ particles coated thereon. The underlying LFP surface particles, which are non-spherical, are still visible, meaning the thickness of the coating of SiO₂ particles, which are spherical, was insufficient.

FIG. 18 is an SEM image of the LFP electrode with 15 layers of SiO₂ particles coated thereon.

FIG. 19 is an SEM image of the LFP electrode with 15 layers of SiO₂ particles coated thereon.

FIG. 20 is an SEM image of the LFP electrode with 15 layers of SiO₂ particles coated thereon.

FIG. 21 is an SEM image of the LFP electrode with 15 layers of SiO₂ particles coated thereon.

FIG. 22 is an SEM image of the LFP electrode with 15 layers of SiO₂ particles coated thereon.

FIG. 23 is a cross-sectional SEM image of the LFP electrode with 15 layers of SiO₂ particles coated thereon.

FIG. 24 is a cross-sectional SEM image of the LFP electrode with 15 layers of SiO₂ particles coated thereon.

FIG. 25 shows the electrochemical performance over the first 10 charge/discharge cycles of an electrochemical device comprising the LFP electrode coated with 15 layers of SiO₂ particles in intimate contact with an uncoated electrode. The results indicate the SiO₂ coating behaved as a porous separator in the electrochemical device.

FIG. 26 shows the electrochemical performance of over the first 100 cycles of an electrochemical device comprising the LFP electrode coated with 15 layers of SiO₂ particles in intimate contact with an uncoated electrode. The results indicate the SiO₂ coating behaved as a porous separator in the electrochemical device.

FIG. 27 is the size distribution DLS data of colloidal SiO₂ nanoparticle dispersion after synthesis and washing.

FIG. 28 is the correlation function of the DLS data from FIG. 27 showing goodness of fit for size distribution.

FIG. 29 is the XRD pattern of a MTI graphite electrode on copper foil current collector.

FIG. 30 is the XRD pattern of a MTI LiCoO₂ electrode on aluminum foil current collector.

FIG. 31 is the XRD pattern of SiO₂ nanoparticles.

FIG. 32 is an SEM image of MTI LiCoO₂ electrode.

FIG. 33 is an EDX elemental map of cobalt for the MTI LiCoO₂ electrode shown in FIG. 32.

FIG. 34 is an EDX elemental map of oxygen for the MTI LiCoO₂ electrode shown in FIG. 32.

FIG. 35 is an EDX elemental map of carbon for the MTI LiCoO₂ electrode shown in FIG. 32.

FIG. 36 is an SEM image of an MTI graphite electrode.

FIG. 37 is an EDX elemental map of carbon for the MTI graphite electrode shown in FIG. 36.

FIG. 38 is the first 2 cycles for half-cells using MTI Corporation LiCoO₂ electrodes, a polypropylene separator, 1 M LiClO₄ EC:DMC:FEC (45:45:10), and a lithium metal anode to verify the electrochemical performance of the MTI electrodes.

FIG. 39 is the first 2 cycles for half-cells using MTI Corporation graphite electrodes, a polypropylene separator, 1 M LiClO₄ EC:DMC:FEC (45:45:10), and a lithium metal anode to verify the electrochemical performance of the MTI electrodes.

FIG. 40 is a photograph of SiO₂ coated LCO electrodes.

FIG. 41 Optical profilometry of LCO cathode prior to SiO₂ nanoparticle coating.

FIG. 42 optical Profilometry SiO₂ coated LCO cathode.

FIG. 43 is an SEM micrograph showing the morphology of the fresh SiO₂ nanoparticles.

FIG. 44 is an SEM micrograph showing the morphology of the SiO₂ nanoparticles after exposure to 1 M LiClO₄ EC:DMC:FEC for 24 hours.

FIG. 45 is an SEM micrograph showing the morphology of the SiO₂ nanoparticles after 50 cycles in a full cell against a graphite anode.

FIG. 46 is an SEM micrograph of a traditional polypropylene separator.

FIG. 47 is an electrochemical impedance spectra comparison of a LCO/LiClO₄ EC:DMC:FEC/graphite cell using a polypropylene separator (square data points) and using SiO₂ as a separator (circular data points) with an equivalent circuit shown in the inset.

FIG. 48 is a schematic illustration of the electrode coating process. The SiO₂ nanoparticles were spray deposited onto a composite electrode surface forming a coating that serves as a separator.

FIG. 49 is a SEM micrograph of a bare LiCoO₂ electrode (e.g., after 0 coatings of SiO₂).

FIG. 50 is a SEM micrograph of a LiCoO₂ electrode after 1 coating of SiO₂.

FIG. 51 is a SEM micrograph of a LiCoO₂ electrode after 5 coatings of SiO₂.

FIG. 52 is a SEM micrograph of a LiCoO₂ electrode after 10 coatings of SiO₂.

FIG. 53 is a SEM micrograph of a LiCoO₂ electrode after 20 coatings of SiO₂.

FIG. 54 is a SEM micrograph of a LiCoO₂ electrode after 50 coatings of SiO₂.

FIG. 55 is a cross-sectional SEM micrograph showing the thickness of SiO₂ separator layer coating on the LiCoO₂ cathode.

FIG. 56 is a cross-sectional SEM micrograph showing the wetting behavior of the SiO₂ separator layer coating on the LiCoO₂ cathode.

FIG. 57 shows the EDS mapping of a cross-section of a SiO₂ coated LCO sample.

FIG. 58 shows the optical profilometry of a fresh SiO₂ coated LiCoO₂ cathode.

FIG. 59 shows the discharge capacity left axis, square data points) and cycle efficiency (right axis, circular data points) of a full cell with a polypropylene separator (full cell schematic is shown in the inset).

FIG. 60 shows the discharge capacity (left axis, square data points) and cycle efficiency (right axis, circular data points) of a full cell with an SiO₂ nanoparticle coating as a separator (full cell schematic is shown in the inset).

FIG. 61 shows the electrochemical impedance spectra of a LCO/LiClO₄ EC:DMC:FEC/graphite cell with a polypropylene separator (square data points) and with SiO₂ as a separator (circular data points); an equivalent circuit is shown in the inset.

FIG. 62 SiO₂ coated LCO electrode (left) and Celgard covered LCO electrode (right) prior to being heated at 150° C. for 30 minutes.

FIG. 63 SiO₂ coated LCO electrode (left) and Celgard covered LCO electrode (right) after being heated at 150° C. for 30 minutes.

FIG. 64 is an XPS survey scan of an SiO₂ coated LiCoO₂ cathode as prepared (bottom trace) and after 50 charge/discharge cycles (upper trace) in a full cell with a graphite anode and 1 M LiClO₄ EC:DMC:FEC as the electrolyte.

FIG. 65 is a high resolution XPS scan of the Si 2p region of an SiO₂ coated LiCoO₂ cathode as prepared and after 50 charge/discharge cycles in a full cell with a graphite anode and 1 M LiClO₄ EC:DMC:FEC as the electrolyte. Dashed lines on the high-resolution spectra represent spectra fits.

FIG. 66 is a high resolution scan of the O 1s region of an SiO₂ coated LiCoO₂ cathode as prepared and after 50 charge/discharge cycles in a full cell with a graphite anode and 1 M LiClO₄ EC:DMC:FEC as the electrolyte. Dashed lines on the high-resolution spectra represent spectra fits.

FIG. 67 is an XPS survey scan of the same as prepared and cycled sample presented in FIG. 64-FIG. 66, but after 10 seconds of Ar sputtering.

FIG. 68 is a high resolution scan of the Si 2p region of the same as prepared and cycled sample presented in FIG. 64-FIG. 66, but after 10 seconds of Ar sputtering. Dashed lines on the high-resolution spectra represent spectra fits.

FIG. 69 is a high resolution scan of the O 1s region of the same as prepared and cycled sample presented in FIG. 64-FIG. 66, but after 10 seconds of Ar sputtering. Dashed lines on the high-resolution spectra represent spectra fits.

FIG. 70 is the high resolution XPS spectra of the C 1s region of an as prepared SiO₂ coated LiCoO₂ cathode. Bold lines represent peaks revealed from spectra fitting and overall fitting envelopes.

FIG. 71 is the high resolution XPS spectra of the C 1s region of an SiO₂ coated LiCoO₂ cathode after 50 charge/discharge cycles in a full cell with a graphite anode and 1 M LiClO₄ EC:DMC:FEC. Bold lines represent peaks revealed from spectra fitting and overall fitting envelopes.

FIG. 72 is the high resolution XPS spectra of the Li 1s region of an as prepared SiO₂ coated LiCoO₂ cathode. Bold lines represent peaks revealed from spectra fitting and overall fitting envelopes.

FIG. 73 is the high resolution XPS spectra of the Li 1s region of an SiO₂ coated LiCoO₂ cathode after 50 charge/discharge cycles in a full cell with a graphite anode and 1 M LiClO₄ EC:DMC:FEC. Bold lines represent peaks revealed from spectra fitting and overall fitting envelopes.

FIG. 74 is the high resolution XPS Spectra of the C 1s region after 10 seconds of Ar-sputtering of an as prepared SiO₂ coated LiCoO₂ cathode. Bold lines represent peaks revealed from spectra fitting and overall fitting envelopes.

FIG. 75 is the high resolution XPS Spectra of the C 1s region after 10 seconds of Ar-sputtering of an SiO₂ coated LiCoO₂ cathode after 50 charge/discharge cycles in a full cell with a graphite anode. Bold lines represent peaks revealed from spectra fitting and overall fitting envelopes.

FIG. 76 is the high resolution XPS Spectra of the Li 1s region after 10 seconds of Ar-sputtering of an as prepared SiO₂ coated LiCoO₂ cathode. Bold lines represent peaks revealed from spectra fitting and overall fitting envelopes.

FIG. 77 is the high resolution XPS Spectra of the Li 1s region after 10 seconds of Ar-sputtering of an SiO₂ coated LiCoO₂ cathode after 50 charge/discharge cycles in a full cell with a graphite anode. Bold lines represent peaks revealed from spectra fitting and overall fitting envelopes.

FIG. 78 is the ATR FTIR spectra of an SiO₂ coated LiCoO₂ cathode as prepared (red, top trace), after being exposed to 1 M LiClO₄ EC:DMC:FEC for 24 hours (blue, middle trace), and after being cycled for 50 cycles in a full cell with a graphite anode with 1 M LiClO₄ EC:DMC:FEC as an electrolyte (magenta, bottom trace).

FIG. 79 is the TOF-SIMS depth profiles for ClO₄⁻ as a function of sputter time of an SiO₂ coated LiCoO₂ cathode as prepared (red, bottom trace), after being exposed to 1 M LiClO₄ EC:DMC:FEC for 24 hours (blue, middle trace), and after being cycled for 50 cycles in a full cell with a graphite anode with 1 M LiClO₄ EC:DMC:FEC as an electrolyte (magenta, top trace).

FIG. 80 is the TOF-SIMS depth profiles for HClO₄ as a function of sputter time of an SiO₂ coated LiCoO₂ cathode as prepared (red, bottom trace), after being exposed to 1 M LiClO₄ EC:DMC:FEC for 24 hours (blue, middle trace), and after being cycled for 50 cycles in a full cell with a graphite anode with 1 M LiClO₄ EC:DMC:FEC as an electrolyte (magenta, top trace).

FIG. 81 is the TOF-SIMS depth profiles for LiClO₄ as a function of sputter time of an SiO₂ coated LiCoO₂ cathode as prepared (red, bottom trace), after being exposed to 1 M LiClO₄ EC:DMC:FEC for 24 hours (blue, middle trace), and after being cycled for 50 cycles in a full cell with a graphite anode with 1 M LiClO₄ EC:DMC:FEC as an electrolyte (magenta, top trace).

FIG. 82 is the TOF-SIMS depth profiles for SiO² as a function of sputter time of an SiO₂ coated LiCoO₂ cathode as prepared (red), after being exposed to 1 M LiClO₄ EC:DMC:FEC for 24 hours (blue), and after being cycled for 50 cycles in a full cell with a graphite anode with 1 M LiClO₄ EC:DMC:FEC as an electrolyte (magenta).

FIG. 83 is the normalized depth profiles and 3D ion concentration renderings for SiO₂ coated LCO cathodes soaked in 1 M LiClO₄ EC:DMC:FEC for 24 hrs.

FIG. 84 is the compiled 3D renderings from FIG. 83 for 24 hours-soaked sample.

FIG. 85 is the Normalized depth profiles and 3D ion concentration renderings for SiO₂ coated LCO cathodes cycled 50 times in 1 M LiClO₄ EC:DMC:FEC.

FIG. 86 is the compiled 3D renderings from FIG. 85 for sample cycled 50 times.

FIG. 87 is a photograph of a SiO₂ coated LCO electrode prior to any rolling or folding.

FIG. 88 is a photograph of the SiO₂ coated LCO electrode from FIG. 87 after being rolled.

FIG. 89 is a photograph of the SiO₂ coated LCO electrode from FIG. 87 after being folded.

FIG. 90A-FIG. 90H shows a wetting experiment of a SiO₂ coated LCO electrode (FIG. 90A-FIG. 90D) compared to a polypropylene separator (FIG. 90E-FIG. 90H).

### DETAILED DESCRIPTION

The devices and methods described herein may be understood more readily by reference to the following detailed description of specific aspects of the disclosed subject matter and the Examples included therein.

Before the present devices and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

Disclosed herein are electrochemical devices comprising a coated electrode. The coated electrode comprises a first electrode and a porous separator layer, wherein the porous separator layer is coated on the first electrode. The porous separator layer comprises a plurality of electrically insulating particles and a plurality of pores.

In some examples, the porous separator layer consists essentially of the plurality of electrically insulating particles and the plurality of pores. In some examples, the porous separator layer consists of the plurality of electrically insulating particles and the plurality of pores.

The electrochemical devices further comprises a second electrode and an electrolyte, wherein the coated electrode is in contact (e.g., intimate contact) with the second electrode such that the porous separator layer is disposed between (e.g., sandwiched between) the first electrode and the second electrode and the porous separator layer is in contact with the first electrode and the second electrode, and wherein the electrolyte is in electrochemical contact with the first electrode and the second electrode (e.g., via the pores of the porous separator layer), such that the liquid electrochemically connects the coated electrode and the second electrode. The electrolyte can, for example, comprise a liquid electrolyte or a solid electrolyte. The solid electrolyte can, for example, be formed in situ from a liquid precursor in contact with the electrode assembly.

The plurality of electrically insulating particles can comprise any suitable electrically insulating material, for example any material that is electrically insulating and is chemically and electrochemically compatible with the electrochemical device. For example, the plurality of electrically insulating particles can comprise an organic electrical insulator, an inorganic electrical insulator, or a combination thereof. In some examples, the plurality of electrically insulating particles can further comprise a dopant. The dopant can be selected, for example, in view of the desired properties of the coated electrode.

In some examples, the plurality of electrically insulating particles can comprise (doped or undoped): Al₂O₃, SiO₂, BeO, Si₂O₃, Ga₂O₃, HfO₂, MgO, MoO₃, Sc₂O₃, Ta₂O₅, ZrO₂, Si₃N₄, AlN, BN, graphitic carbon nitride, P₃N₅, SiC, CaC₂, BaTiO₃, Ba(Sr)TiO₃, Ba(Pb)TiO₃, PbTiO₃, PbZnO₃, Pb(Zn,Ti)O₃, Pb(La)TiO₃, Pb(La)Zn(Ti)O₃, SrTiO₃, LiNbO₃, LiTaO₃, Pb(Mg, Nb)O₃, Pb(Mg,Nb)O₃:PbTiO₃, B₄Ti₃O₁₂, BaFe₁₂O₁₉, or combinations thereof. In some examples, the plurality of electrically insulating particles can comprise glass, quartz, porcelain, ceramic, kaolin, mica, steatite, sapphire, slate, or combinations thereof.

In some examples, the plurality of electrically insulating particles can comprise an electrically insulating polymer. Examples of electrically insulating polymers include, but are not limited to, polyethylene, polypropylene, poly(methyl methacrylate), polyvinyl alcohol, polyvinyl chloride, polystyrene, polyhaloethylene, polyacrylate, polyamide, polycarbonate, polyester, polyimide, polymethylpentene, polytetrafluoroethylene, polyethylene terephthalate, poly p-chloroxylylene, polyurethane, an epoxide resin, derivatives thereof, copolymers thereof, blends thereof, or combinations thereof.

In some examples, the plurality of electrically insulating particles can comprise self-assembled superlattice/self-assembled nanodielectric (SAS/SAND) materials (e.g., described in Yoon, M-H. et al., PNAS, 102 (13): 4678-4682 (2005)), as well as hybrid organic/inorganic dielectric materials (e.g., described in US 2007/0181961 A1).

The plurality of electrically insulating particles can comprise particles of any shape (e.g., a sphere, a rod, a quadrilateral, an ellipse, a triangle, a polygon, etc.). In some examples, the plurality of electrically insulating particles can have an irregular shape, a regular shape, an isotropic shape, an anisotropic shape, or a combination thereof. In some examples, the plurality of electrically insulating particles can have an isotropic shape. In some examples, the plurality of electrically insulating particles are substantially spherical.

The plurality of electrically insulating particles can have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. Mean particle size can be measured using methods known in the art, such as evaluation by scanning electron microscopy, transmission electron microscopy, and/or dynamic light scattering. As used herein, the average particle size is determined using electron microscopy.

The plurality of electrically insulating particles can, for example, have an average particle size of 50 picometers (pm) or more (e.g., 60 pm or more, 70 pm or more, 80 pm or more, 90 pm or more, 100 pm or more, 125 pm or more, 150 pm or more, 175 pm or more, 200 pm or more, 225 pm or more, 250 pm or more, 300 pm or more, 350 pm or more, 400 pm or more, 450 pm or more, 500 pm or more, 600 pm or more, 700 pm or more, 800 pm or more, 900 pm or more, 1 nanometer (nm) or more, 2 nm or more, 3 nm or more, 4 nm or more, 5 nm or more, 6 nm or more, 7 nm or more, 8 nm or more, 9 nm or more, 10 nm or more, 11 nm or more, 12 nm or more, 13 nm or more, 14 nm or more, 15 nm or more, 16 nm or more, 17 nm or more, 18 nm or more, 19 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, μm) or more, 2 microns or more, 3 microns or more, 4 microns or more, 5 microns or more, 6 microns or more, 7 microns or more, 8 microns or more, 9 microns or more, 10 microns or more, 11 microns or more, 12 microns or more, 13 microns or more, 14 microns or more, 15 microns or more, 16 microns or more, 17 microns or more, 18 microns or more, 19 microns or more, 20 microns or more, 25 microns or more, 30 microns or more, 35 microns or more, 40 microns or more, 45 microns or more, 50 microns or more, 60 microns or more, 70 microns or more, 80 microns or more, 90 microns or more, 100 microns or more, 125 microns or more, 150 microns or more, 175 microns or more, 200 microns or more, 225 microns or more, 250 microns or more, 300 microns or more, 350 microns or more, 400 microns or more, 450 microns or more, 500 microns or more, 600 microns or more, 700 microns or more, 800 microns or more, 900 microns or more, 1 millimeter (mm) or more, 2 mm or more, 3 mm or more, 4 mm or more, 5 mm or more, 6 mm or more, or 7 mm or more).

In some examples, the plurality of electrically insulating particles can have an average particle size of 10 millimeters (mm) or less (e.g., 9 mm or less, 8 mm or less, 7 mm or less, 6 mm or less, 5 mm or less, 4 mm or less, 3 mm or less, 2 mm or less, 1 mm or less, 900 microns or less, 800 microns or less, 700 microns or less, 600 microns or less, 500 microns or less, 450 microns or less, 400 microns or less, 350 microns or less, 300 microns or less, 250 microns or less, 225 microns or less, 200 microns or less, 175 microns or less, 150 microns or less, 125 microns or less, 100 microns or less, 90 microns or less, 80 microns or less, 70 microns or less, 60 microns or less, 50 microns or less, 45 microns or less, 40 microns or less, 35 microns or less, 30 microns or less, 25 microns or less, 20 microns or less, 19 microns or less, 18 microns or less, 17 microns or less, 16 microns or less, 15 microns or less, 14 microns or less, 13 microns or less, 12 microns or less, 11 microns or less, 10 microns or less, 9 microns or less, 8 microns or less, 7 microns or less, 6 microns or less, 5 microns or less, 4 microns or less, 3 microns or less, 2 microns or less, 1 micron or less, 900 nm or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 19 nm or less, 18 nm or less, 17 nm or less, 16 nm or less, 15 nm or less, 14 nm or less, 13 nm or less, 12 nm or less, 11 nm or less, 10 nm or less, 9 nm or less, 8 nm or less, 7 nm or less, 6 nm or less, 5 nm or less, 4 nm or less, 3 nm or less, 2 nm or less, 1 nm or less, 900 pm or less, 800 pm or less, 700 pm or less, 600 pm or less, 500 pm or less, 450 pm or less, 400 pm or less, 350 pm or less, 300 pm or less, 250 pm or less, 225 pm or less, 200 pm or less, 175 pm or less, 150 pm or less, 125 pm or less, 100 pm or less, 90 pm or less, 80 pm or less, or 70 pm or less).

The average particle size of the plurality of electrically insulating particles can range from any of the minimum values described above to any of the maximum values described above. For example, the plurality of electrically insulating particles can have an average particle size of from 50 pm to 10 mm (e.g., from 50 pm to 1 nm, from 1 nm to 10 nm, from 10 nm to 100 nm, from 100 nm to 1 micron, from 1 micron to 10 microns, from 10 microns to 100 microns, from 100 microns to 1 mm, from 1 mm to 10 mm, from 1 nm to 10 mm, from 1 nm to 500 nm, from 500 nm to 1 micron, from 1 micron to 500 microns, from 500 microns to 10 mm, from 100 nm to 400 nm, or from 200 nm to 300 nm).

In some examples, the plurality of electrically insulating particles comprises: a first population of particles comprising a first material and having a first average particle size and a first particle shape; and a second population of particles comprising a second material and having a second average particle size and a second particle shape; wherein the first average particle size and the second average particle size are different, the first particle shape and the second particle shape are different, the first material and the second material are different, or a combination thereof.

In some examples, the plurality of electrically insulating particles comprises: a first population of particles comprising a first material and having a first average particle size and a first particle shape, wherein the first population of particles is arranged in an ordered array; and a second population of particles comprising a second material and having a second average particle size and a second particle shape; wherein the first average particle size and the second average particle size are different, the first particle shape and the second particle shape are different, the first material and the second material are different, or a combination thereof; and wherein the second population of particles are disposed within the ordered array of the first plurality of particles.

In some examples, the plurality of electrically insulating particles comprises: a first population of particles comprising a first material and having a first average particle size and a first particle shape, and wherein the first population of particles is arranged in a first ordered array; and a second population of particles comprising a second material and having a second average particle size and a second particle shape, and wherein the second population of particles is arranged in a second ordered array; wherein the first average particle size and the second average particle size are different, the first particle shape and the second particle shape are different, the first material and the second material are different, the first ordered array and the second ordered array are different, or a combination thereof.

In some examples, the plurality of electrically insulating particles comprises a mixture of a plurality of populations of particles, wherein each population of particles within the mixture has a different size, shape, composition, or combination thereof. In some examples, the plurality of electrically insulating particles within each population of particles are substantially monodisperse.

In some examples, the porous separator layer can comprise a first layer and a second layer, wherein the first layer comprises the first population of particles and the second layer comprises the second population of particles. In some examples, the porous separator layer can comprise a plurality of distinct layers, wherein each layer comprises a population of particles and each population of particles within the mixture has a different size, shape, composition, or combination thereof relative to the layer(s) it is in contact with.

The plurality of electrically insulating particles can, for example, have a packing density of greater than 0% in the porous separator layer (e.g., 1% or more, 2% or more, 3% or more, 4% or more, 5% or more, 10% or more, 15% or more, 20% or more, 25% or more, 30% or more, 35% or more, 40% or more, 45% or more, 50% or more, 55% or more, 60% or more, 65% or more, 70% or more, 75% or more, 80% or more, 85% or more, 90% or more, or 95% or more). In some examples, the plurality of electrically insulating particles can have a packing density of 100% or less in the porous separator layer (e.g., 99% or less, 98% or less, 97% or less, 96% or less, 95% or less, 90% or less, 85% or less, 80% or less, 75% or less, 70% or less, 65% or less, 60% or less, 55% or less, 50% or less, 45% or less, 40% or less, 35% or less, 30% or less, 25% or less, 20% or less, 15% or less, 10% or less, or 5% or less). The packing density of the plurality of electrically insulating particles in the porous separator layer can range from any of the minimum values described above to any of the maximum values described above. For example, the plurality of electrically insulating particles can be from greater than 0% to 100% (e.g., from greater than 0% to 50%, from 50% to 100%, form greater than 0% to 20%, from 20% to 40%, from 40% to 60%, from 60% to 80%, from 80% to 100%, from 60% to 90%, or from 70% to 80%).

In some examples, the plurality of electrically insulating particles can be functionalized. For example, the plurality of electrically insulating particles can be functionalized to adjust the wetting behavior of the porous separator layer by the liquid electrolyte or the liquid precursor to the solid electrolyte. In some examples, the plurality of electrically insulating particles can be functionalized such that they are oleophilic, hydrophilic, or a combination thereof. In some examples, the plurality of electrically insulating particles can be functionalized to adjust the packing behavior of the plurality of electrically insulating particles (e.g., to adjust the porosity of the porous separator layer). In some examples, the plurality of electrically insulating particles can be functionalized to adjust the coordination between the plurality of electrically insulating particles and the first electrode. In some examples, the plurality of electrically insulating particles can be functionalized to adjust: their dielectric properties; their electrically insulative properties; their chemical compatibility with the first electrode, the second electrode, the electrolyte, the liquid precursor, or combination thereof; to suppress or prevent alkali metal dendrite growth; to assist alkali metal ion conduction; or a combination thereof. In some examples, the plurality of electrically insulating particles can be functionalized so as to exhibit the phenomenon described by Pfaffenhuber et al. PhysChemChemPhys, 2013, 15, 18318-18335. In some examples, the plurality of electrically insulating particles can be functionalized so as to spontaneously form the solid electrolyte in situ on contact with the liquid precursor.

The plurality of pores can have an average characteristic dimension. The term “characteristic dimension,” as used herein, refers to the largest cross-sectional dimension of a pore in a plane perpendicular to the longitudinal axis of the pore. For example, in the case of a substantially cylindrical pore in the porous separator layer, the characteristic dimension of the pore would be the diameter of the pore. The characteristic dimension of a pore can be determined, for example, using electron microscopy (e.g., scanning electron microscopy (SEM), transmission electron microscopy (TEM), high-resolution TEM (HRTEM), scanning transmission electron microscopy (STEM)), Brunauer-Emmett-Teller (BET) measurements, or a combination thereof. As used herein, the characteristic pore dimension is determined using electron microscopy.

The plurality of pores can, for example, have an average characteristic dimension of 0.25 nm or more (e.g., 0.5 nm or more, 1 nm or more, 1 nm or more, 2 nm or more, 2.5 nm or more, 3 nm or more, 3.5 nm or more, 4 nm or more, 4.5 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, μm) or more, 2 microns or more, 3 microns or more, 4 microns or more, 5 microns or more, 10 microns or more, 15 microns or more, 20 microns or more, 25 microns or more, 30 microns or more, 35 microns or more, 40 microns or more, 45 microns or more, 50 microns or more, 60 microns or more, 70 microns or more, 80 microns or more, 90 microns or more, 100 microns or more, 125 microns or more, 150 microns or more, 175 microns or more, 200 microns or more, 225 microns or more, 250 microns or more, 300 microns or more, 350 microns or more, 400 microns or more, 450 microns or more, 500 microns or more, 600 microns or more, 700 microns or more, 800 microns or more, or 900 microns or more). In some examples, the plurality of pores can have an average characteristic dimension of 1 mm or less (e.g., 900 microns or less, 800 microns or less, 700 microns or less, 600 microns or less, 500 microns or less, 450 microns or less, 400 microns or less, 350 microns or less, 300 microns or less, 250 microns or less, 225 microns or less, 200 microns or less, 175 microns or less, 150 microns or less, 125 microns or less, 100 microns or less, 90 microns or less, 80 microns or less, 70 microns or less, 60 microns or less, 50 microns or less, 45 microns or less, 40 microns or less, 35 microns or less, 30 microns or less, 25 microns or less, 20 microns or less, 15 microns or less, 10 microns or less, 5 microns or less, 4 microns or less, 3 microns or less, 2 microns or less, 1 micron or less, 900 nm or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, 5 nm or less, 4.5 nm or less, 4 nm or less, 3.5 nm or less, 3 nm or less, 2.5 nm or less, 2 nm or less, 1 nm or less, or 1 nm or less).

The average characteristic dimension of the plurality of pores can range from any of the minimum values described above to any of the maximum values described above. For example, the plurality of pores can have an average characteristic dimension of from 0.25 nm to 1 mm (e.g., from 0.25 nm to 10 nm, from 10 nm to 100 nm, from 100 nm to 1 micron, from 1 micron to 10 microns, from 10 microns to 100 microns, from 100 microns to 1 mm, from 0.25 nm to 500 nm, from 500 nm to 1 micron, from 1 micron to 500 microns, from 500 microns to 1 mm, or from 500 nm to 1 mm).

In some examples, the porous separator layer has an average porosity of 20% or more (e.g., 25% or more, 30% or more, 35% or more, 40% or more, or 45% or more). In some examples, the porous separator layer can have an average porosity of 50% or less (e.g., 45% or less, 40% or less, 35% or less, 30% or less, or 25% or less). The average porosity of the porous separator layer can range from any of the minimum values described above to any of the maximum values described above. For example, the porous separator layer can have an average porosity of from 20% to 50% (e.g., from 20% to 35%, from 35% to 50%, from 20% to 30%, from 30% to 40%, from 40% to 50%, or from 25% to 45%).

In some examples, the plurality of electrically insulating particles can comprise a plurality of porous particles. In some examples, the porous separator layer consists essentially of the plurality of porous particles. In some examples, the porous separator layer consists of the plurality of porous particles.

The porous separator layer can have a thickness sufficient to prevent electrical contact between the first electrode and the second electrode. For example, the porous separator layer can have an average thickness of 1 nm or more (e.g., 2 nm or more, 3 nm or more, 4 nm or more, 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, μm) or more, 2 microns or more, 3 microns or more, 4 microns or more, 5 microns or more, 6 microns or more, 7 microns or more, 8 microns or more, 9 microns or more, 10 microns or more, 11 microns or more, 12 microns or more, 13 microns or more, 14 microns or more, 15 microns or more, 16 microns or more, 17 microns or more, 18 microns or more, 19 microns or more, 20 microns or more, 25 microns or more, 30 microns or more, 35 microns or more, 40 microns or more, 45 microns or more, 50 microns or more, 60 microns or more, 70 microns or more, 80 microns or more, 90 microns or more, 100 microns or more, 125 microns or more, 150 microns or more, 175 microns or more, 200 microns or more, 225 microns or more, 250 microns or more, 300 microns or more, 350 microns or more, 400 microns or more, 450 microns or more, 500 microns or more, 600 microns or more, 700 microns or more, 800 microns or more, 900 microns or more, 1 millimeter (mm) or more, 2 mm or more, 3 mm or more, 4 mm or more, 5 mm or more, 10 mm or more, 15 mm or more, 20 mm or more, 25 mm or more, 30 mm or more, 35 mm or more, 40 mm or more, 45 mm or more, 50 mm or more, 60 mm or more, 70 mm or more, or 80 mm or more).

In some examples the porous separator layer can have an average thickness of 100 mm or less (e.g., 90 mm or less, 80 mm or less, 70 mm or less, 60 mm or less, 50 mm or less, 45 mm or less, 40 mm or less, 35 mm or less, 30 mm or less, 25 mm or less, 20 mm or less, 15 mm or less, 10 mm or less, 5 mm or less, 4 mm or less, 3 mm or less, 2 mm or less, 1 mm or less, 900 microns or less, 800 microns or less, 700 microns or less, 600 microns or less, 500 microns or less, 450 microns or less, 400 microns or less, 350 microns or less, 300 microns or less, 250 microns or less, 225 microns or less, 200 microns or less, 175 microns or less, 150 microns or less, 125 microns or less, 100 microns or less, 90 microns or less, 80 microns or less, 70 microns or less, 60 microns or less, 50 microns or less, 45 microns or less, 40 microns or less, 35 microns or less, 30 microns or less, 25 microns or less, 20 microns or less, 19 microns or less, 18 microns or less, 17 microns or less, 16 microns or less, 15 microns or less, 14 microns or less, 13 microns or less, 12 microns or less, 11 microns or less, 10 microns or less, 9 microns or less, 8 microns or less, 7 microns or less, 6 microns or less, 5 microns or less, 4 microns or less, 3 microns or less, 2 microns or less, 1 micron or less, 900 nm or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 19 nm or less, 18 nm or less, 17 nm or less, 16 nm or less, 15 nm or less, 14 nm or less, 13 nm or less, 12 nm or less, 11 nm or less, 10 nm or less, 9 nm or less, 8 nm or less, 7 nm or less, 6 nm or less, or 5 nm or less).

The average thickness of the porous separator layer can range from any of the minimum values described above to any of the maximum values described above. For example, the porous separator layer can have an average thickness of from 1 nm to 100 mm (e.g., from 1 nm to 10 nm, from 10 nm to 100 nm, from 100 nm to 1 micron, from 1 micron to 10 microns, from 10 microns to 100 microns, from 100 microns to 1 mm, from 1 mm to 10 mm, from 10 mm to 100 mm, from 1 nm to 500 nm, from 500 nm to 1 micron, from 1 micron to 500 microns, from 500 microns to 1 mm, from 1 mm to 100 mm, from 1 nm to 1 mm, from 1 nm to 500 microns, from 1 nm to 50 microns, from 1 nm to 20 microns, from 1 nm to 12 microns, from 1 nm to 10 microns, from 1 nm to 5 microns, or from 1 nm to 1 micron).

The electrolyte can, for example, comprise a liquid electrolyte or a solid electrolyte. The solid electrolyte can, for example, be formed in situ from a liquid precursor in contact with the electrode assembly. For example, the solid electrolyte can infiltrate the porous separator layer through the plurality of pores such that the solid electrolyte is in electrochemical contact with the first electrode and the second electrode. In some examples, the plurality of electrically insulating particles can be functionalized so as to spontaneously form the solid electrolyte in situ on contact with the liquid precursor. In some examples, the liquid precursor can be contacted with the electrolyte assembly, such that the liquid precursor infiltrates the porous separator layer, and then liquid precursor can be contacted with a reactant so as to form the solid electrolyte in situ. Suitable solid electrolytes and precursors therefor are known in the art, as are methods of forming solid electrolytes in situ. The in situ formation of a solid electrolyte is described, for example, by Zhao et al. Nature Energy, 2019, DOI: 10.1038/s41560-019-0349-7.

The solid electrolyte can, for example, comprise a solid organic electrolyte, a solid inorganic electrolyte, or a combination thereof. In some examples, the solid electrolyte can comprise a polymer (e.g., a (co)polymer derived from ethylene oxide and optionally a conomoner, such as polyethylene oxide), a ceramic electrolyte, or a combination thereof. For example, the solid electrolyte can comprise a ceramic-halide composite which can comprise any halide compound suitable for a working ion for a rechargeable battery (e.e., lithium halide, sodium halide, potassium halide, magnesium halide, zinc halide, etc.) mixed with any non-electronically conducting ceramic (e.g., Al₂O₃, SiO₂, etc.). In certain examples, the solid electrolyte can comprise a ceramic-halide composite such as LiI—Al₂O₃, LiI—SiO₂, LiF—Al₂O₃, LiF—SiO₂, and the like.

Suitable liquid electrolytes are known in the art. The liquid electrolyte can, for example, comprise a H⁺ electrolyte, a Li⁺ electrolyte, a Mg²⁺ electrolyte, a Na⁺ electrolyte, a K⁺ electrolyte, an Al⁺ electrolyte, a Zn²⁺ electrolyte, a KOH electrolyte, or combinations thereof.

In some examples, the liquid electrolyte comprises a solvent with a dissolved ion source. The dissolved ion source can, for example, comprise an alkali metal ion source. In some examples, the ion source comprises H⁺ ions, Li⁺ ions, Na⁺ ions, K⁺ ions, Mg²⁺ ions, Ca²⁺ ions, Al³⁺ ions, or combinations thereof. The solvent can, for example, comprise monoglyme, diglyme, tetraglyme, ethylene carbonate (EC), propylene carbonate, dimethyl carbonate (DMC), diethyl carbonate, fluoroethylene carbonate (FEC), dimethyl sulfoxide (DMSO), dimethyl formamide (DMF), dimethoxyethane, acetonitrile, water, and combinations thereof.

In some examples, at least a portion of the plurality of electrically insulating particles can be functionalized by the liquid electrolyte or a derivative thereof. In some examples, the liquid electrolyte or derivative thereof can be bound or coordinated to at least a portion of the plurality of electrically insulating particles. For example, the liquid electrolyte can comprise a Li⁺ electrolyte, wherein the Li⁺ electrolyte can comprise a Li⁺ component and a solvent, and at least a portion of the plurality of electrically insulating particles can be functionalized by, bound to, and/or coordinated with the Li⁺ component, the solvent, derivatives thereof, or combinations thereof. In some examples, the liquid electrolyte can comprise a solvent with a dissolved ion source and at least a portion of the plurality of electrically insulating particles can be functionalized by, bound to, and/or coordinated with the ion source, the solvent, derivatives thereof, or combinations thereof.

In some examples, the porous separator layer can consist essentially of the plurality of pores and the plurality of electrically insulating particles, wherein at least a portion of the plurality of electrically insulating particles are functionalized by the liquid electrolyte or a derivative thereof. In some examples, the porous separator can consist of the plurality of pores and the plurality of electrically insulating particles, wherein at least a portion of the plurality of electrically insulating particles are functionalized by the liquid electrolyte or a derivative thereof.

In some examples, the plurality of electrically insulating particles can comprise a plurality of porous particles, wherein at least a portion of the plurality of porous particles are functionalized by the liquid electrolyte or a derivative thereof. In some examples, the porous separator layer can consist essentially of the plurality of porous particles, wherein at least a portion of the plurality of porous particles are functionalized by the liquid electrolyte or a derivative thereof. In some examples, the porous separator layer can consist of the plurality of porous particles, wherein at least a portion of the plurality of porous particles are functionalized by the liquid electrolyte or a derivative thereof.

The first electrode and/or the second electrode can comprise an active material, a transparent conducting oxide, a metal oxide, a conducting polymer, a carbon material, a metal, or a combination thereof.

Examples of suitable active materials include, but are not limited to lithium compounds, sulfur compounds (e.g., sulfides), sodium compounds, potassium compounds, oxygen compounds, magnesium compounds, calcium compounds, or combinations thereof. In some examples, the active material can comprise lithium cobalt oxide (LiCoO₂), lithium iron phosphate (LiFePO₄), lithium manganese oxide (LiMn₂O₄, Li₂MnO₃), lithium nickel manganese cobalt oxide (LiNiMnCoO₂), lithium nickel cobalt aluminum oxide (LiNiCoAlO₂), lithium nickel manganese aluminum oxide, lithium titanate (Li₄Ti₅O₁₂), LiNi_{0.5}Mn_{1.5}O₄, or combinations thereof. The first electrode and/or the second electrode can, in some examples, comprise lithium iron phosphate. The first electrode and/or the second electrode can, in some examples, comprise lithium cobalt oxide.

Examples of suitable carbon-based conductive materials include, but are not limited to graphitic carbon and graphites, including pyrolytic graphite (e.g., highly ordered pyrolytic graphite (HOPG)) and isotropic graphite, amorphous carbon, carbon black, single- or multi-walled carbon nanotubes, graphene, glassy carbon, diamond-like carbon (DLC) or doped DLC, such as boron-doped diamond, pyrolyzed photoresist films, and others known in the art. The first electrode and/or the second electrode can, in some examples, comprise graphite.

In some examples, the first electrode and/or the second electrode can comprise a metal oxide and the metal oxide comprises an alkali metal (e.g., Li, Na, K, Rb, Cs, Fr, or combinations thereof); an alkali earth metal (e.g., Mg, Ca, Sr, Ba, Ra, or combinations thereof); a group 3 metal (e.g., Al, Ga, In, Tl, or combinations thereof); a group 4 metal or metalloid (e.g., Si, Ge, Sn, Pb, or combinations thereof); a transition metal; or combinations thereof.

In some examples, the first electrode and/or the second electrode can comprise a metal oxide and the metal oxide can comprise a transition metal selected from a first row transition metal (e.g., Sc, Ti, V, Cr, Mn, Fe, Co, Ni, Cu, Zn, and combinations thereof); a second row transition metal (e.g., Y, Zr, Nb, Mo, Tc, Ru, Rh, Pd, Ag, Cd, and combinations thereof); a third row transition metal (e.g., Lu, Hf, Ta, W, Re, Os, Ir, Pt, Au, Hg, or combinations thereof); and combinations thereof. In some examples, the first electrode and/or the second electrode can comprise a metal oxide and the metal oxide comprises a metal selected from the group consisting of Cd, Cr, Cu, Ga, In, Ni, Sn, Ti, W, Zn, Sc, V, Mn, Fe, Co, and combinations thereof. In some examples, the first electrode and/or the second electrode can comprise CdO, CdIn₂O₄, Cd₂SnO₄, Cr₂O₃, CuCrO₂, CuO₂, Ga₂O₃, In₂O₃, NiO, SnO₂, TiO₂, ZnGa₂O₄, ZnO, InZnO, InGaZnO, InGaO, ZnSnO, Zn₂SnO₄, CdSnO, WO₃, NbO, Li₄Ti₅O₁₂, or combinations thereof.

The first electrode and/or the second electrode can have an average thickness of 1 nm or more (e.g., 5 nm or more, 10 nm or more, 15 nm or more, 20 nm or more, 25 nm or more, 30 nm or more, 40 nm or more, 50 nm or more, 75 nm or more, 100 nm or more, 125 nm or more, 150 nm or more, 200 nm or more, 250 nm or more, 300 nm or more, 400 nm or more, 500 nm or more, 750 nm or more, 1 micrometer (micron, pm) or more, 5 microns or more, 10 microns or more, 15 microns or more, 20 microns or more, 25 microns or more, 30 microns or more, 40 microns or more, 50 microns or more, 75 microns or more, 100 microns or more, 125 microns or more, 150 microns or more, 200 microns or more, 250 microns or more, 300 microns or more, 400 microns or more, 500 microns or more, 750 microns or more, 1 millimeter (mm) or more, or 5 mm or more). In some examples, the first electrode and/or the second electrode can have an average thickness of 10 mm or less (e.g., 5 mm or less, 1 mm or less, 750 microns or less, 500 microns or less, 400 microns or less, 300 microns or less, 250 microns or less, 200 microns or less, 150 microns or less, 125 microns or less, 100 microns or less, 75 microns or less, 50 microns or less, 40 microns or less, 30 microns or less, 25 microns or less, 20 microns or less, 15 microns or less, 10 microns or less, 5 microns or less, 1 micron or less, 750 nm or less, 500 nm or less, 400 nm or less, 300 nm or less, 250 nm or less, 200 nm or less, 150 nm or less, 125 nm or less, 100 nm or less, 75 nm or less, 50 nm or less, 40 nm or less, 30 nm or less, 25 nm or less, 20 nm or less, 15 nm or less, 10 nm or less, or 5 nm or less).

The average thickness of the first electrode and/or the second electrode can range from any of the minimum values described above to any of the maximum values described above. For example, the first electrode and/or the second electrode can have an average thickness of from 1 nm to 10 mm (e.g., from 1 nm to 10 nm, from 10 nm to 100 nm, from 100 nm to 1 micron, from 1 micron to 10 microns, from 10 microns to 100 microns, from 100 microns to 1 mm, from 1 mm to 10 mm, from 1 nm to 500 nm, from 500 nm to 1 micron, from 1 micron to 500 microns, from 500 microns to 10 mm, from 5 nm to 5 mm, or from 10 nm to 1 mm).

When the coated electrode is in contact with the second electrode such that the porous separator layer is disposed between (e.g., sandwiched between) the first electrode and the second electrode and the porous separator layer is in contact with the first electrode and the second electrode, an electrode assembly is formed.

The electrode assembly can have an average thickness of 3 nm or more (e.g., 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micron or more, 2 microns or more, 3 microns or more, 4 microns or more, 5 microns or more, 10 microns or more, 15 microns or more, 20 microns or more, 25 microns or more, 30 microns or more, 35 microns or more, 40 microns or more, 45 microns or more, 50 microns or more, 60 microns or more, 70 microns or more, 80 microns or more, 90 microns or more, 100 microns or more, 125 microns or more, 150 microns or more, 175 microns or more, 200 microns or more, 225 microns or more, 250 microns or more, 300 microns or more, 350 microns or more, 400 microns or more, 450 microns or more, 500 microns or more, 600 microns or more, 700 microns or more, 800 microns or more, 900 microns or more, 1 millimeter (mm) or more, 2 mm or more, 3 mm or more, 4 mm or more, 5 mm or more, 10 mm or more, 15 mm or more, 20 mm or more, 25 mm or more, 30 mm or more, 35 mm or more, 40 mm or more, 45 mm or more, 50 mm or more, 60 mm or more, 70 mm or more, 80 mm or more, 90 mm or more, 100 mm or more, 125 mm or more, 150 mm or more, 175 mm or more, or 200 mm or more).

In some examples, the electrode assembly can have an average thickness of 250 mm or less (e.g., 250 mm or less, 200 mm or less, 175 mm or less, 150 mm or less, 125 mm or less, 100 mm or less, 90 mm or less, 80 mm or less, 70 mm or less, 60 mm or less, 50 mm or less, 45 mm or less, 40 mm or less, 35 mm or less, 30 mm or less, 25 mm or less, 20 mm or less, 15 mm or less, 10 mm or less, 5 mm or less, 4 mm or less, 3 mm or less, 2 mm or less, 1 mm or less, 900 microns or less, 800 microns or less, 700 microns or less, 600 microns or less, 500 microns or less, 450 microns or less, 400 microns or less, 350 microns or less, 300 microns or less, 250 microns or less, 225 microns or less, 200 microns or less, 175 microns or less, 150 microns or less, 125 microns or less, 100 microns or less, 90 microns or less, 80 microns or less, 70 microns or less, 60 microns or less, 50 microns or less, 45 microns or less, 40 microns or less, 35 microns or less, 30 microns or less, 25 microns or less, 20 microns or less, 15 microns or less, 10 microns or less, 5 microns or less, 4 microns or less, 3 microns or less, 2 microns or less, 1 micron or less, 900 nm or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, or 5 nm or less).

The average thickness of the electrode assembly can range from any of the minimum values described above to any of the maximum values described above. For example, the electrode assembly can have an average thickness of from 3 nm to 250 mm (e.g., from 3 nm to 10 nm, from 10 nm to 100 nm, from 100 nm to 1 micron, from 1 micron to 10 microns, from 10 microns to 100 microns, from 100 microns to 1 mm, from 1 mm to 10 mm, from 10 mm to 100 mm, from 100 mm to 250 mm, from 1 nm to 500 nm, from 500 nm to 1 micron, from 1 micron to 500 microns, from 500 microns to 1 mm, from 1 mm to 250 mm, or from 5 nm to 200 mm).

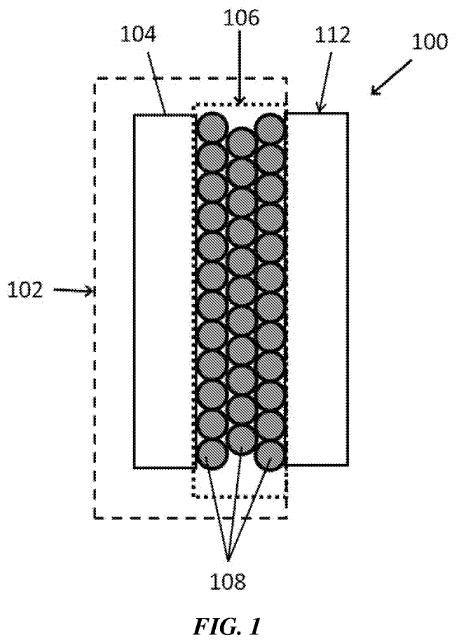

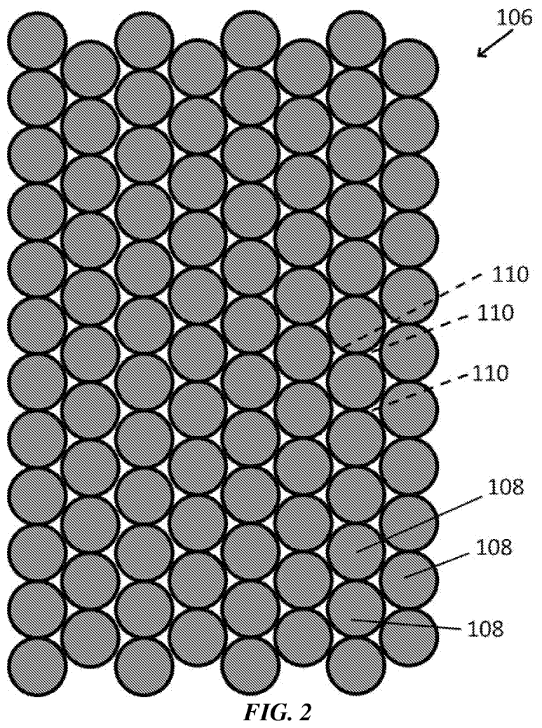

FIG. 1 shows a side view of the electrode assembly. Referring now to FIG. 1, the electrode assembly 100 comprises a coated electrode 102 comprising a first electrode 104 and a porous separator layer 106, wherein the porous separator layer 106 comprises a plurality of electrically insulating particles 108 and a plurality of pores 110 (the plurality of pores 110 can, for example, be the spaces between the plurality of electrically insulating particles 108, as shown in the top view of the porous separator layer 106 in FIG. 2), wherein the porous separator layer 106 is coated on the first electrode 104; a second electrode 112; and wherein the coated electrode 102 is in contact with the second electrode 112 such that the porous separator layer 106 is disposed between the first electrode 104 and the second electrode 112 and the porous separator layer 106 is in contact with the first electrode 104 and the second electrode 112.

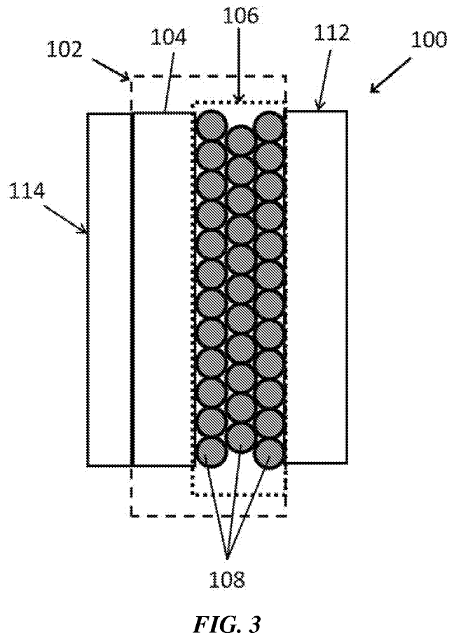

In some examples, the electrochemical device can further comprise a first current collector. Referring now to FIG. 3, the first current collector 114 can be arranged within the electrode assembly 100 such that the first electrode 104 is in contact with the first current collector 114 and the porous separator layer 106 such that the first electrode 104 is disposed between the first current collector 114 and the porous separator layer 106. The first current collector can, for example, comprise a metal, a carbon material, or a combination thereof. In some examples, the first current collector can comprise a metal foil and/or a metal foam. In some examples, the first current collector can comprise copper, nickel, aluminum, or a combination thereof. Examples of suitable carbon-based conductive materials include, but are not limited to graphitic carbon and graphites, including pyrolytic graphite (e.g., highly ordered pyrolytic graphite (HOPG)) and isotropic graphite, amorphous carbon, carbon black, single- or multi-walled carbon nanotubes, graphene, glassy carbon, diamond-like carbon (DLC) or doped DLC, such as boron-doped diamond, pyrolyzed photoresist films, and others known in the art.

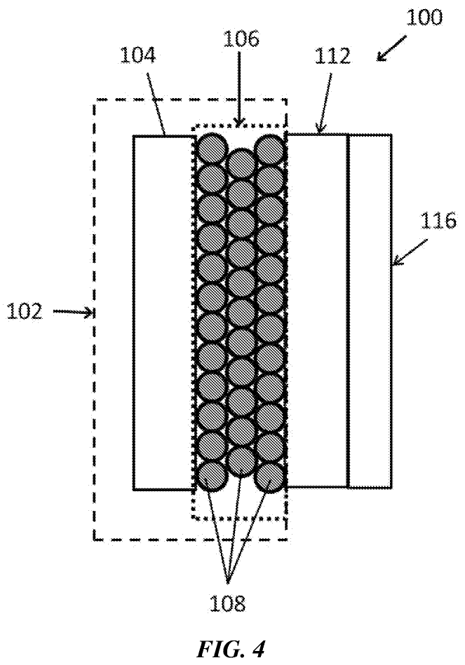

In some examples, the electrochemical device can further comprise a second current collector. Referring now to FIG. 4, the second current collector 116 can be arranged within the electrode assembly 100 such that the second electrode 112 is in contact with the second current collector 116 and the porous separator layer 106 such that the second electrode 112 is disposed between the second current collector 116 and the porous separator layer 106. The second current collector can, for example, comprise a metal, a carbon material, or a combination thereof. In some examples, the second current collector can comprise a metal foil and/or a metal foam. In some examples, the second current collector can comprise copper, nickel, aluminum, or a combination thereof. Examples of suitable carbon-based conductive materials include, but are not limited to graphitic carbon and graphites, including pyrolytic graphite (e.g., highly ordered pyrolytic graphite (HOPG)) and isotropic graphite, amorphous carbon, carbon black, single- or multi-walled carbon nanotubes, graphene, glassy carbon, diamond-like carbon (DLC) or doped DLC, such as boron-doped diamond, pyrolyzed photoresist films, and others known in the art.

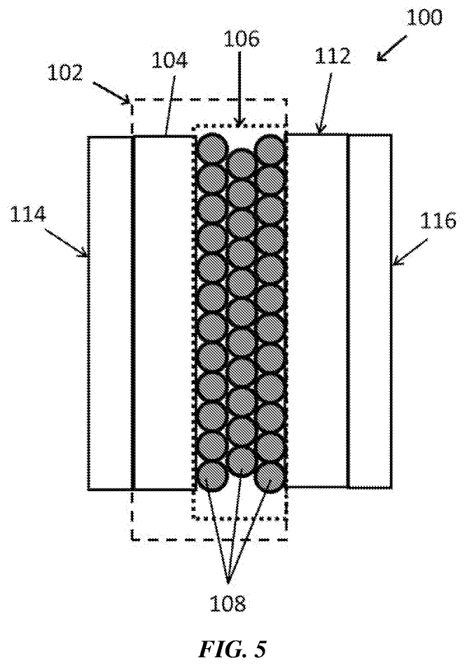

Referring now to FIG. 5, in some examples, the electrochemical device can comprise a first current collector 114 and a second current collector 116.

In some examples, the electrochemical devices described herein can exhibit improved power density compared to an electrochemical device with a traditional sheet-like porous separator.

In some examples, the electrochemical devices described herein can exhibit improved durability compared to an electrochemical device with a traditional sheet-like porous separator. For example, the electrochemical devices described herein can exhibit improved capacity retention after 10 cycles or more (e.g., 15 cycles or more, 20 cycles or more, 30 cycles or more, or 50 cycles or more) compared to an electrochemical device with a traditional sheet-like porous separator. As used herein, a cycle refers to charging and discharging the electrochemical device. In some examples, the porous separators described herein can exhibit improved durability (e.g., improved morphological stability) compared to a traditional sheet-like porous separator. In some examples, the porous separators described herein can exhibit improved durability after 10 cycles or more compared to a traditional sheet-like porous separator.

In some examples, the electrochemical devices described herein can comprise a stacked electrode assembly comprising a plurality of electrode assemblies stacked on one another. In some examples, the stacked electrode assembly can comprise a plurality of the coated electrodes and a plurality of the second electrodes, the plurality of coated electrodes and the plurality of second electrodes being alternately stacked with the porous separator layer interposed between each of the plurality of coated electrodes and the plurality of second electrodes.

In some examples, the electrochemical device can comprise a battery, an electrolytic cell (e.g., electrolyzer, electroplating), or a galvanic cell.

Also described herein are methods of making any of the electrochemical devices described herein. The methods of making the electrochemical devices described herein can comprise dispersing the plurality of electrically insulating particles in a solvent, thereby forming a mixture. Dispersing the plurality of electrically insulating particles in the solvent can be accomplished by mechanical agitation, for example, mechanical stirring, shaking, vortexing, sonication (e.g., bath sonication, probe sonication), and the like, or combinations thereof. The solvent can, for example, comprise tetrahydrofuran (THF), dimethylformamide (DMF), dichloromethane (CH₂Cl₂), ethylene glycol, ethanol, methanol, propanol, isopropanol, water, acetonitrile, chloroform, acetone, hexane, heptane, toluene, methyl acetate, ethyl acetate, and combinations thereof. In some examples, the method can further comprise making the plurality of electrically insulating particles.

The methods further comprise depositing the mixture on the first electrode, thereby coating the porous separator layer on the first electrode and forming the coated electrode. Depositing the plurality of electrically insulating particles can, for example, comprise printing, lithographic deposition, electron beam deposition, thermal deposition, sputtering, pulsed laser deposition, evaporation, other laser deposition methods, spin coating, drop-casting, zone casting, dip coating, blade coating, spray coating, vacuum filtration, or combinations thereof. In some examples, the methods can further comprise repeating the depositing step one or more times to achieve the desired thickness of the porous separator layer and/or the desired number of layers of different populations of electrically insulating particles within the porous separator layer. In some examples, the methods can further comprise allowing the deposited porous separator layer to dry by evaporating the solvent from the deposited porous separator layer (e.g., by application of heat and/or ventilation).

The methods further comprise sandwiching the porous separator layer between the first electrode and the second electrode, thereby forming an electrode assembly; and contacting the electrode assembly with the electrolyte (e.g., contacting the electrode assembly with the liquid electrolyte or contacting the electrode assembly with the liquid precursor to form the solid electrolyte in situ), thereby forming the electrochemical device.

In some examples, the methods can further comprise closing (e.g., sealing) the electrochemical device, for example within a container.

The examples below are intended to further illustrate certain aspects of the methods and compounds described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

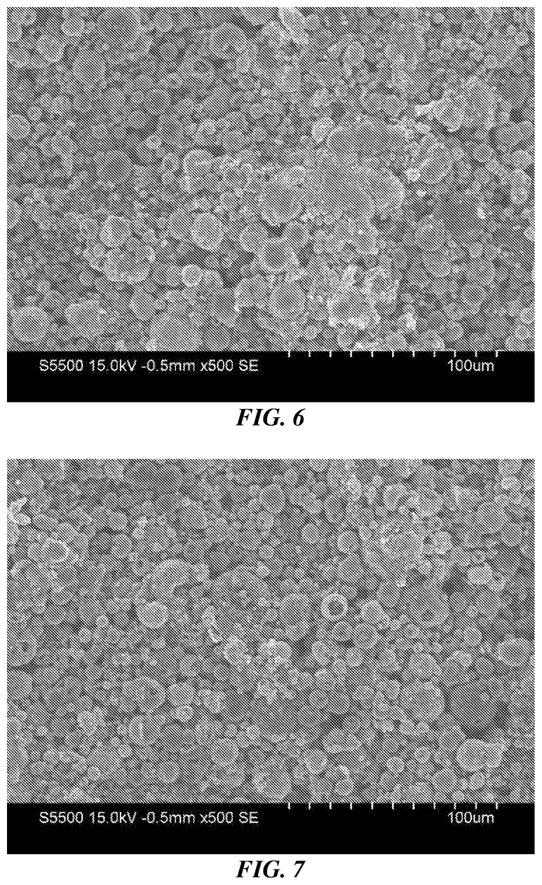

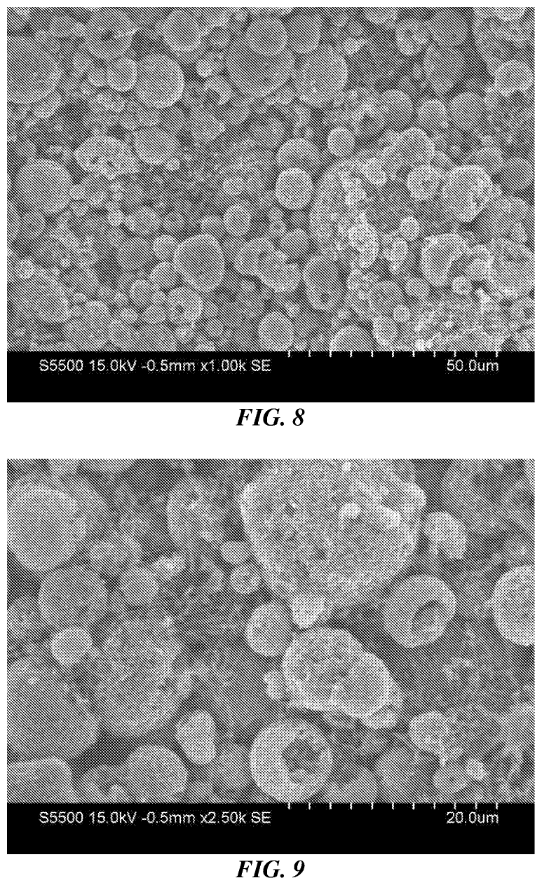

Described herein are example coated electrodes and batteries including said coated electrodes. The electrode material was lithium iron phosphate (LFP). The uncoated LFP electrodes had surfaces that were substantially rough on the microscopic scale, comprising particles roughly 5-20 microns in size, as can be seen in the scanning electron microscopy images shown in FIG. 6-FIG. 9.

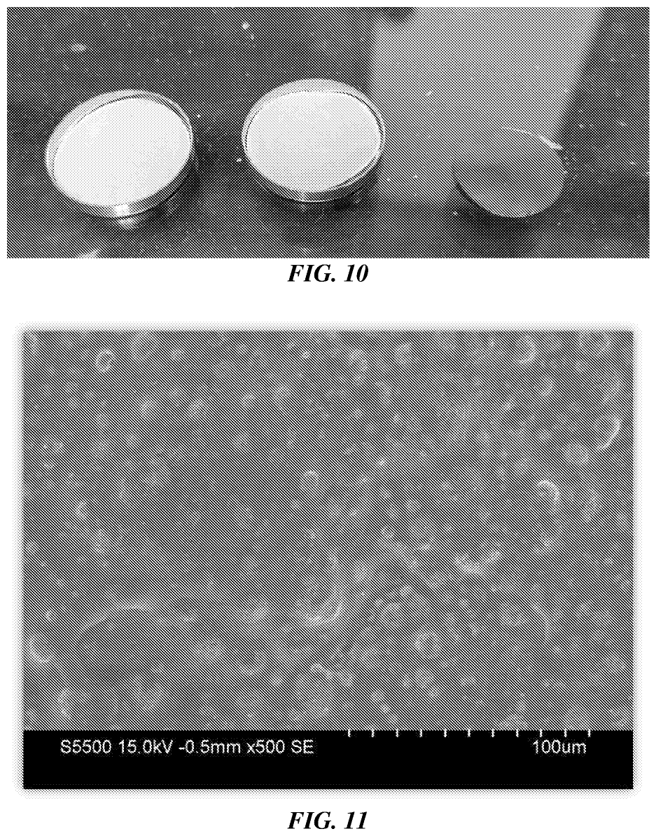

The LFP electrodes were coated with SiO₂ particles (˜250 nm in diameter) by spraying a mixture of the SiO₂ particles dispersed in a mixture of water and ethanol onto the LFP electrodes. A photograph of an example of the coated (left two electrodes) and uncoated (right) LFP electrodes is shown in in FIG. 10.

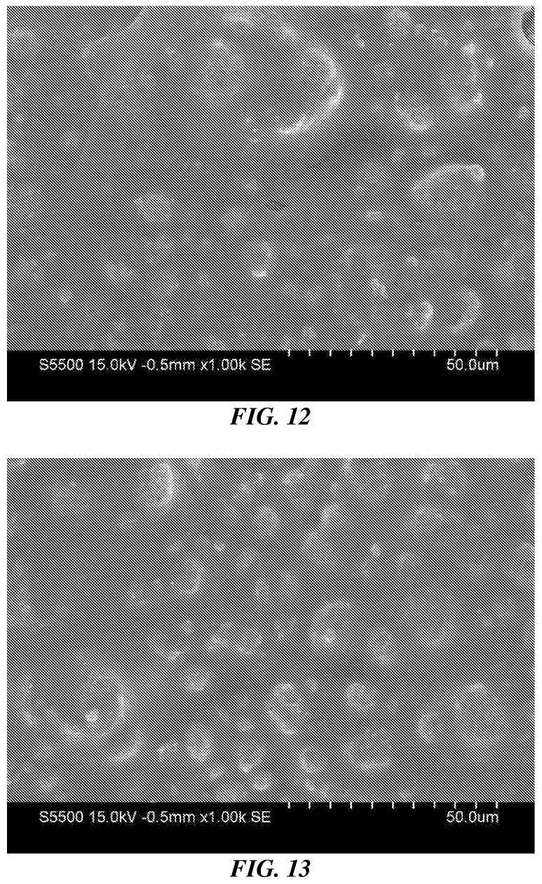

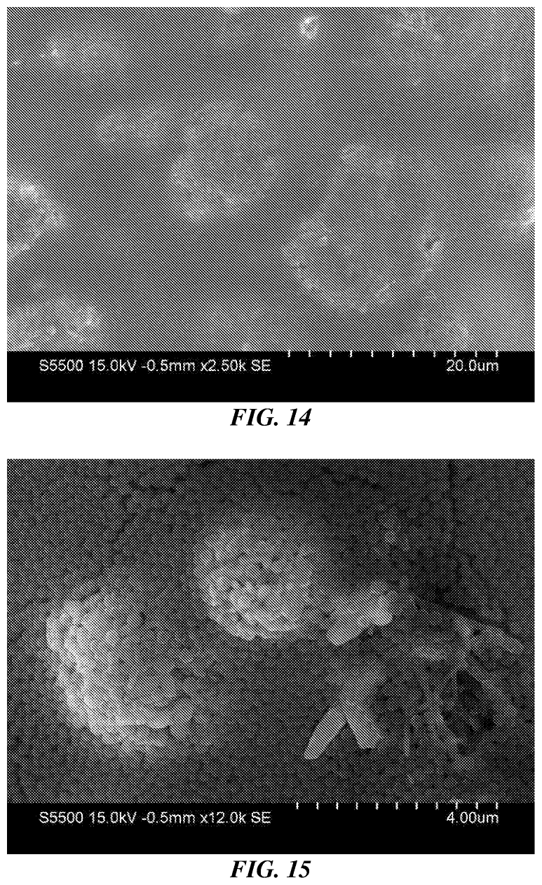

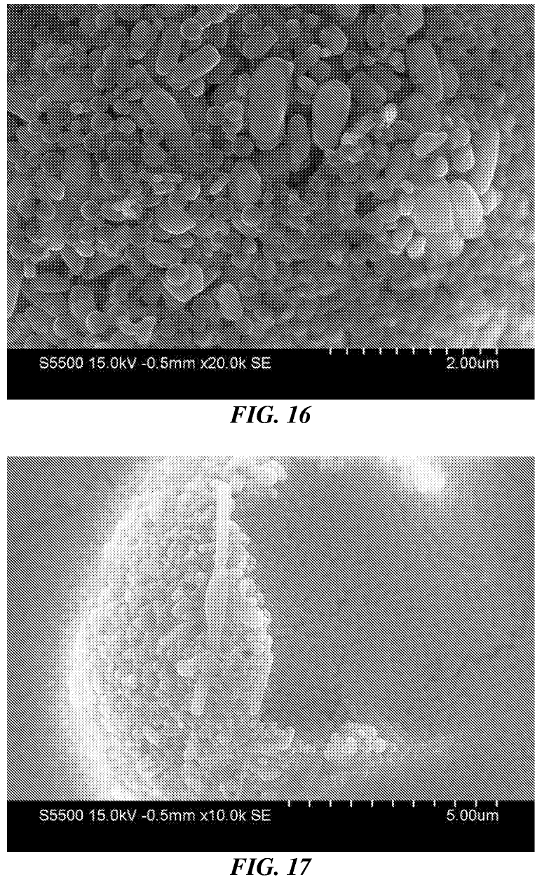

SEM images of a coating comprising five layers of the SiO₂ particles deposited on an LFP electrode are shown in FIG. 11-FIG. 17. The five layers of the SiO₂ particles resulted in a coating of insufficient thickness to fully coat the underlying surface features of the LFP. As shown in FIG. 15-FIG. 17, the underlying LFP surface particles, which are non-spherical, are still visible, meaning the thickness of the coating of SiO₂ particles, which are spherical, was insufficient. Accordingly, this coated electrode would not be able to be put into intimate contact with another electrode in a battery, as the portions of the LFP electrode sticking through the coating on the coated electrode would cause a short in the battery, as they would be in direct contact with the other electrode.

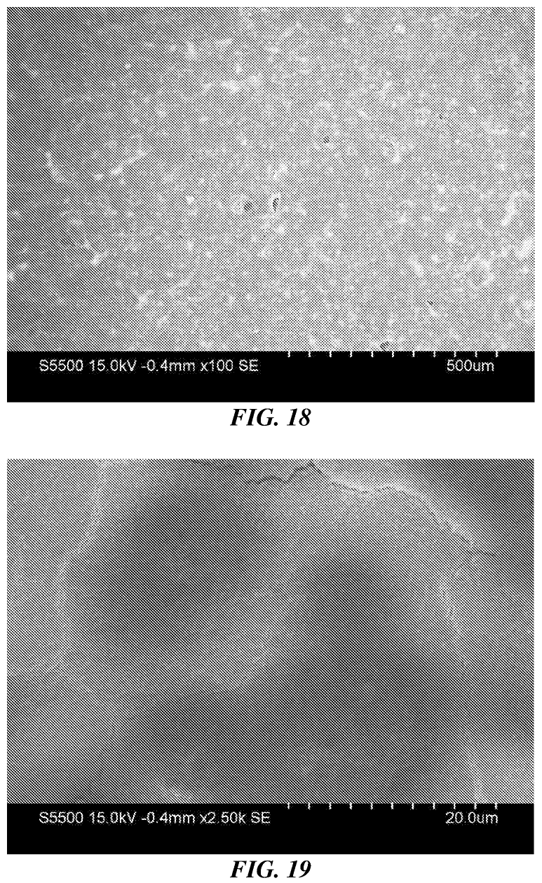

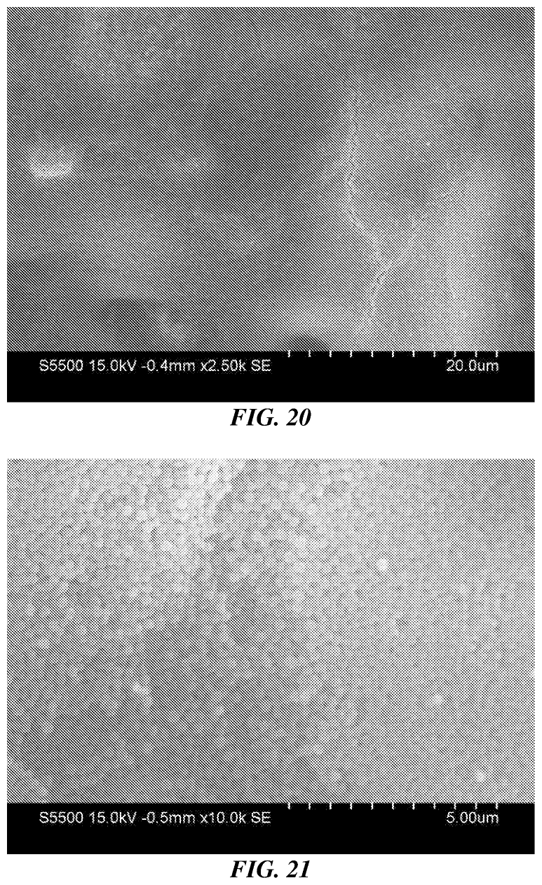

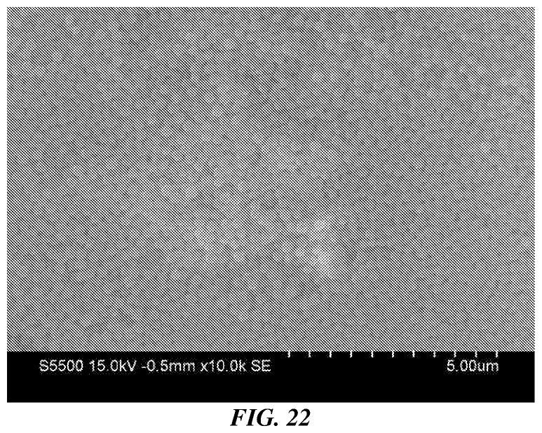

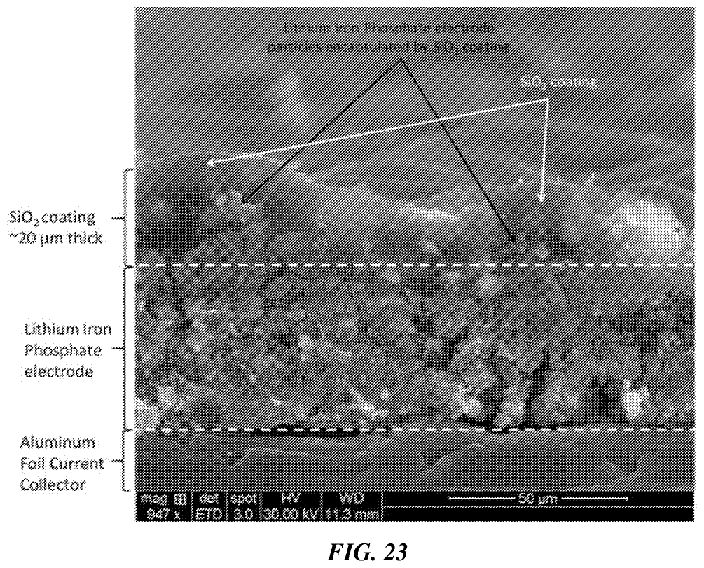

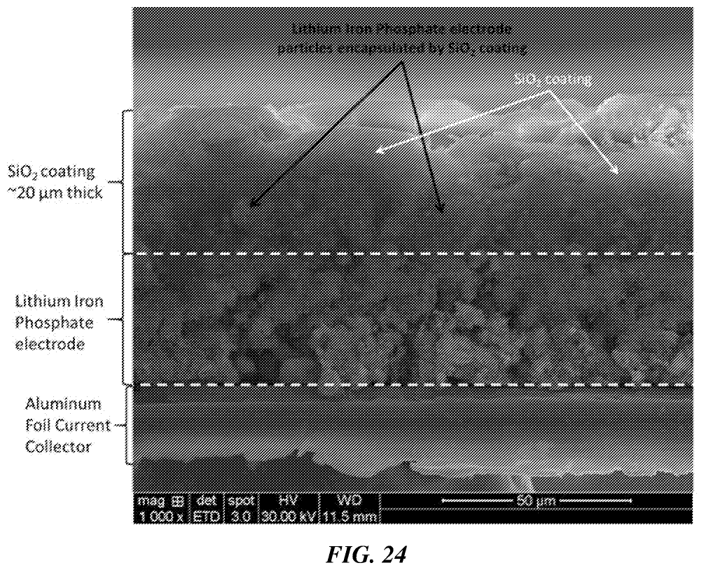

SEM images of a coating comprising fifteen layers of the SiO₂ particles deposited on an LFP electrode are shown in FIG. 18-FIG. 22. As can be seen in FIG. 18-FIG. 22, the 15 layers of SiO₂ particles were sufficient to full coat the LFP electrode. Example cross-sectional SEM images of the LFP electrode coated with 15 layers of the SiO₂ particles are shown in FIG. 23 and FIG. 24.

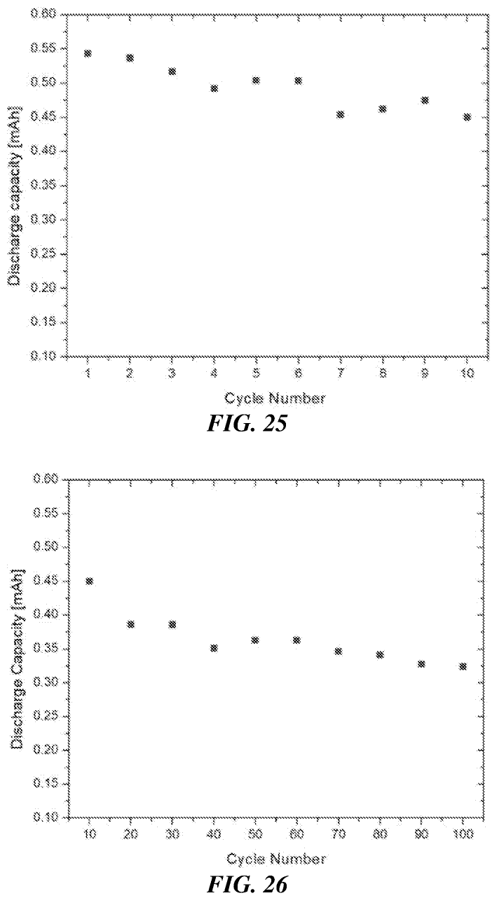

As the coating comprising 15 layers of the SiO₂ particles sufficiently coated the LFP electrode, this coated electrode was assembled with an uncoated electrode in a coin cell to test the electrochemical performance of the deposited coating of SiO₂ particles as a porous separator in the cell. The electrochemical performance over the first 10 charge/discharge cycles of the electrochemical device is shown in FIG. 25. The electrochemical performance of the electrochemical device over the first 100 cycles is shown in FIG. 26. These results indicate the assembled cell performed as an electrochemical device, meaning the coating of SiO₂ particles behaved as a porous separator and the coated electrode was able to be in intimate contact with the other electrode in the electrochemical device.

### Example 2

Rechargeable battery cells having a liquid electrolyte require a separator permeable to the electrolyte between the two electrodes. Because the electrodes change their volume during charge and discharge, the porous separators typically have been polymers with an electronic energy gap E_{g} large enough for the Fermi levels of the two electrodes to be within it.

Materials for rechargeable Li-ion batteries make up 65% of the overall cost of a cell and the polymer separator is about 11% of the material cost (Berckmans et al. Energies 2017, 10(9), 1314); for a Na-ion cell, the cost of the polymer separator is estimated to be 20% of the material cost (Arora et al. Chemical Reviews 2004, 104(10), 4419-62). Polymer separators were developed to retain the plasticity of the electrolyte at the electrode/electrolyte interface in order to accommodate the electrode volume changes during a charge/discharge cycle. Although cost reduction is one of the priorities of battery development, the cost of the separator has generally been overlooked as an avenue for cost reduction by those developing cells with a liquid electrolyte. Moreover, whether the conventional polymer separator is optimal for a given cell design is also overlooked (Vaalma et al. Nature Reviews Materials 2018, 3, 18013).

In order for a separator to remain electrochemically inactive, it needs to be an electronic insulator with a large energy gap E_{g} between its conduction and valence bands. Simple, environmentally friendly oxides can have a large energy gap; and in the form of a small particle, they can form a plastic membrane containing the liquid electrolyte.

Nanoparticles have been used in “Soggy-Sand” electrolytes (Pfaffenhuber et al. Physical Chemistry Chemical Physics 2013, 15(42), 18318-35), as coatings of polymer separators (Augustin et al. Desalination 2002, 146(1), 23-28; Weber et al. AIP Conf. Proc. 2014, 1597, 66-81; Lee et al. Energy & Environmental Science 2014, 7(12), 3857-86), or in conjunction with a polymer matrix (Arora et al. Chemical Reviews 2004, 104(10), 4419-62; Lee et al. Energy & Environmental Science 2014, 7(12), 3857-86; Croce et al. Nature 1998, 394(6692), 456-58; Croce et al. Solid State Ionics, Proceedings of the 12th International Conference on Solid State, 2000, 135(1), 47-52). In each case, the nanoparticles were an additive feature to enhance the cyclability while a polymer remained as the separator. These nanoparticle additives have been shown to improve the ability of the separator to be wetted by an organic-liquid electrolyte (Lee et al. Energy & Environmental Science 2014, 7(12), 3857-86), to support higher temperature tolerance (Lee et al. Energy & Environmental Science 2014, 7(12), 3857-86), and to have the ability to absorb HF generated by the salt of some organic electrolytes during cycling (Schmuch et al. Nature Energy 2018, 3(4), 267-78). However, the possibility of using nanoparticles and their natural tendency to adhere to each other as a separator membrane has not yet been explored. Soggy-sand electrolytes have been shown to provide many of the benefits described for nanoparticles in batteries as well as to introduce additional benefits such as an increased Li⁺ transference number. Unfortunately, these systems still have significant barriers that have yet to be overcome, such as kinetic instabilities that lead to poor retention of ionic conductivity over long periods of time (Pfaffenhuber et al. Physical Chemistry Chemical Physics 2013, 15(42), 18318-35). The strategy described herein deposits the insulating nanoparticles directly onto the electrode to form a uniform coating that serves as a separator without the need for an expensive polymer and preventing some of the pitfalls of the Soggy-sand system.

Vitreous silica (SiO₂) is environmentally friendly, has a band-gap of 11 eV (Trukhin. Journal of Non-Crystalline Solids 1992, 149(1), 32-45), and is commonly used as a fiberglass separator. SiO₂ nanoparticles are less expensive than fiberglass, are easier to produce in large quantities, and can be easily manipulated. With a strong history of additives in battery separators and having a relatively simple synthesis route, SiO₂ nanoparticles are an attractive choice to serve as a battery separator.

Herein, it is demonstrated that the plasticity of a polymer membrane is not needed for the separator in a liquid electrolyte; a porous film of SiO₂ nanoparticles have the required large E_{g}, and, if adsorbed water and CO₂ are removed from the oxide surface, the SiO₂ particles bond to one another and to an oxide cathode to form a plastic self-assembling porous layer into which the liquid electrolyte can penetrate. The SiO₂ nanoparticles are easy to prepare, cheap, and environmentally friendly.

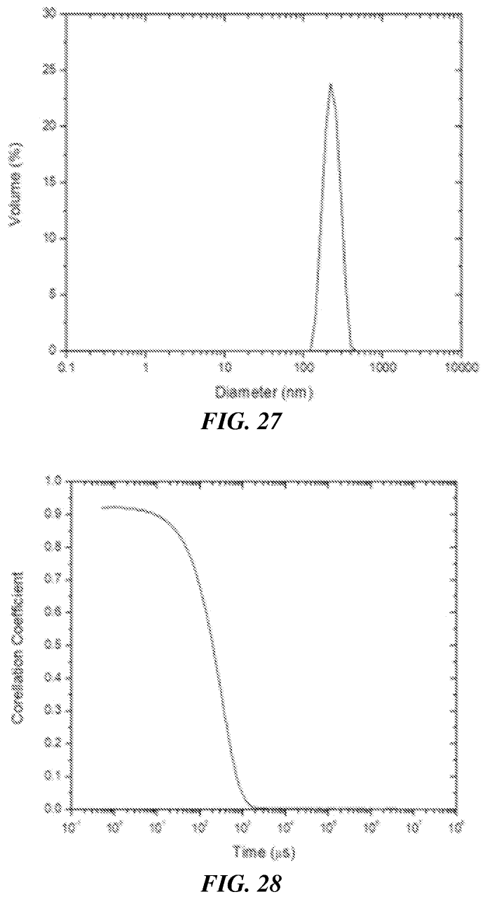

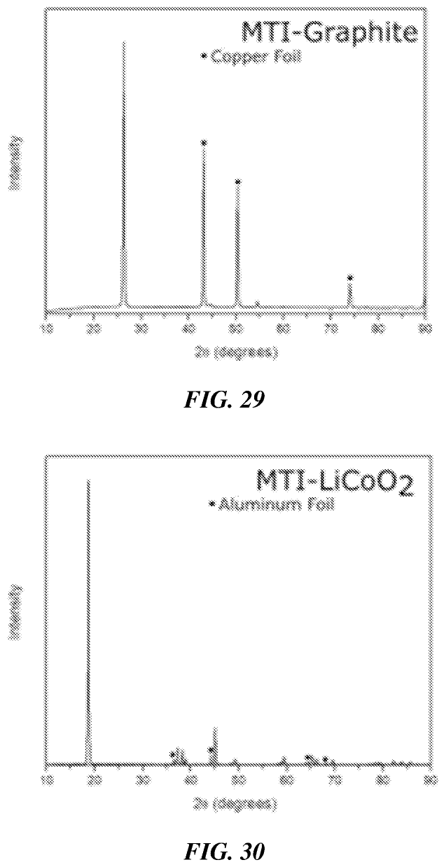

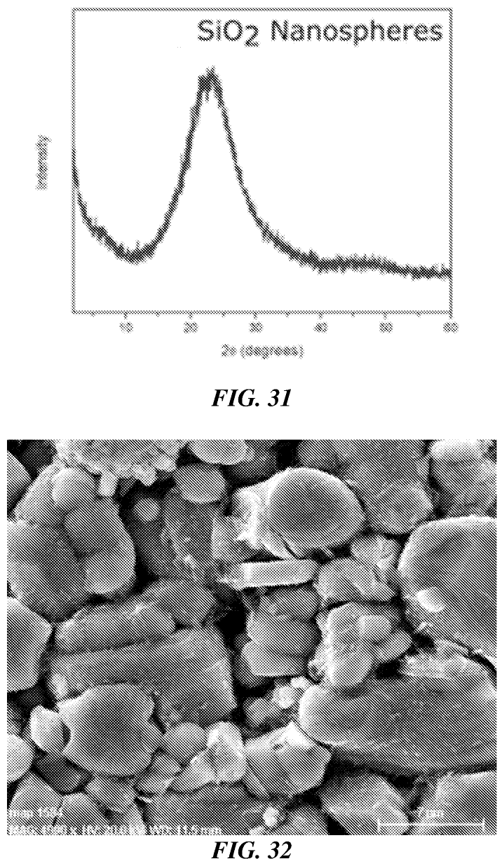

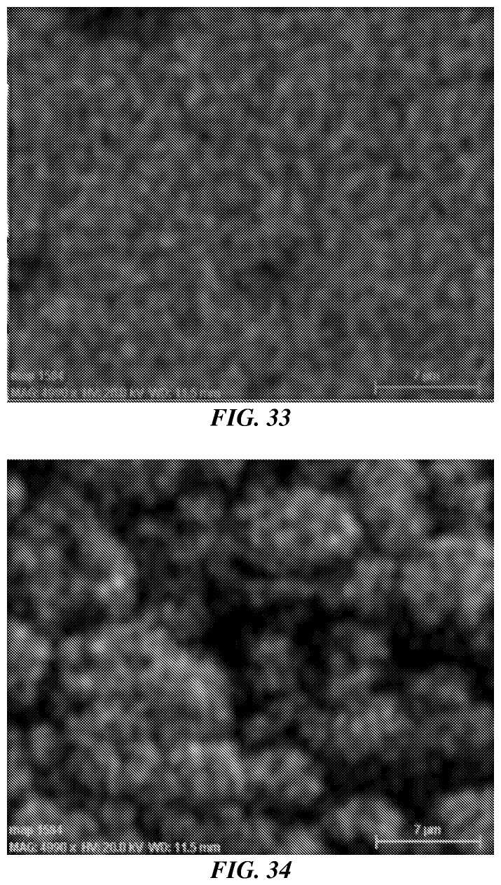

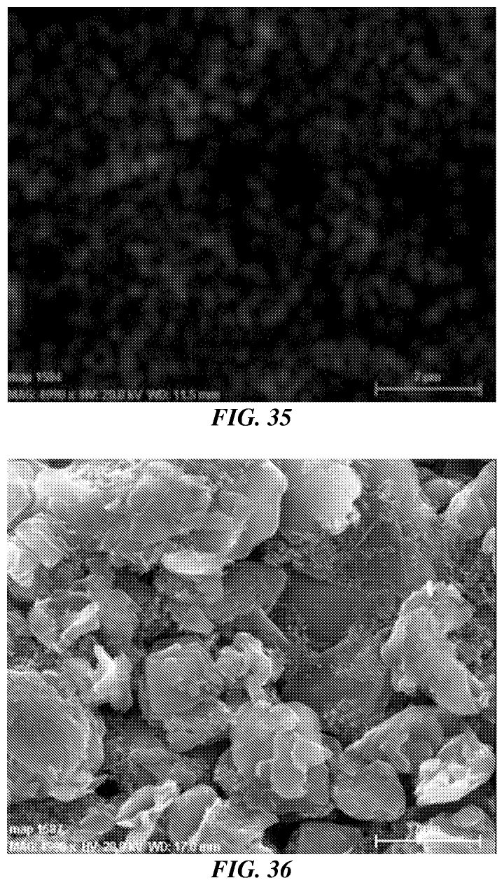

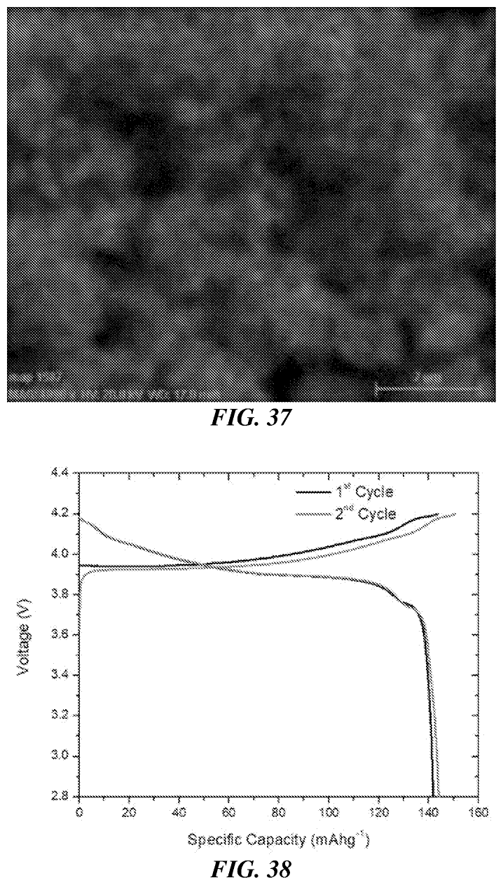

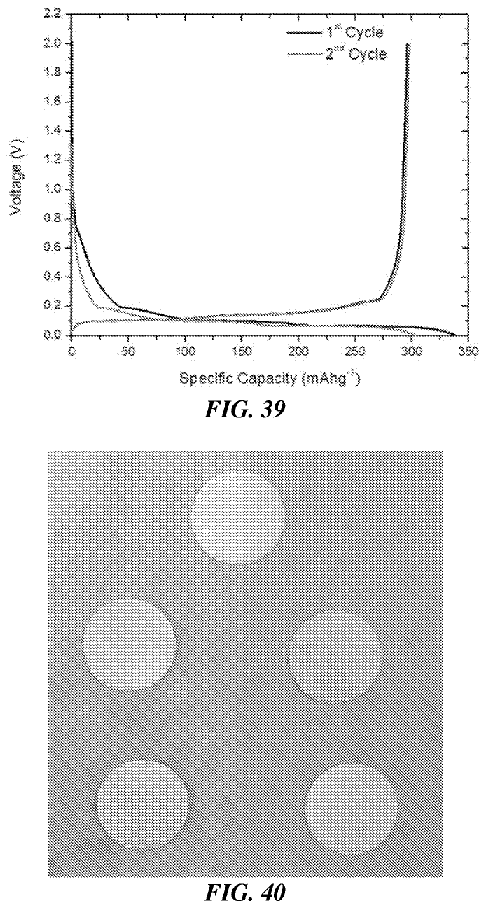

SiO₂ nanoparticles were synthesized with a modified Stoller method (Sato-Berru et al. Journal of Materials Science and Engineering A 2013, 4, 237-242). The nanoparticles were prepared by combining 20 mL distilled water with 30 mL anhydrous ethanol (200 Proof, Decon Labs), 1.5 mL Tetraethyl orthosilicate (TEOS) (98%, Acros Organics), and 3 mL ammonium hydroxide solution (29%, Fisher Scientific). After stirring the solution for one hour, the colloidal dispersion was centrifuged twice with distilled water to wash the SiO₂ nanoparticles. The size of the resulting SiO₂ nanoparticles was 220 nm as determined in aqueous solution with dynamic light scattering (Zetasizer Nano ZS) (FIG. 27-FIG. 28). The shape of the nanoparticles was examined with Scanning Electron Microscopy (SEM) at an accelerating voltage of 20 kV (FEI Quanta 650) and the vitreous nature of the SiO₂ nanoparticles was verified using X-Ray Diffraction (XRD) (Rigaku Miniflex) (FIG. 29-FIG. 31). LiCoO₂ (LCO) and graphite electrodes were purchased from MTI Corp. The structure of the active material of each electrode was verified by XRD (FIG. 29-FIG. 31). Morphology of the electrodes was examined by SEM and the composition and homogeneity of the electrodes were verified with energy dispersive X-ray (EDX) spectroscopy (Bruker EDX) (FIG. 32-FIG. 37). All electrodes and polypropylene separators were dried at 60° C. for 24 hours under vacuum prior to use. Electrochemical performance of the LCO and graphite MTI electrodes was verified with half-cells against a lithium metal electrode with a polypropylene separator and 1 M LiClO₄ EC:DMC:FEC (45:45:10) as the electrolyte cycled at a current density of 0.1 mA/cm² (FIG. 38 and FIG. 39).

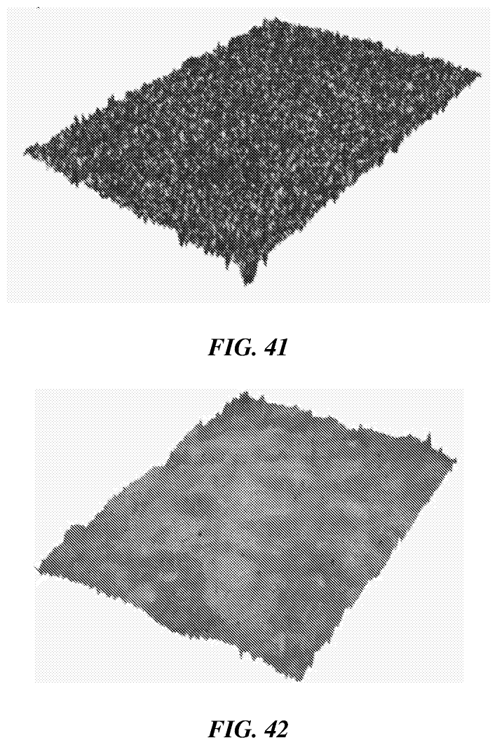

The self-assembly of the SiO₂ nanospheres on an LCO electrode substrate was observed with SEM (Hitachi S5500 SEM/STEM) to ensure that the nanoparticles would properly adhere to the electrode surface prior to cell preparation. Heated LCO cathode sheets (surface temperature: 200° C.) were coated with SiO₂ nanospheres dispersed in distilled H₂O using spray deposition. The H₂O quickly evaporated leaving only SiO₂ nanoparticles on the electrode sheet (FIG. 40). Optical profilometry (Zeta Instruments Z-20) was conducted on a fully coated LCO electrode to ensure coverage over a large area was complete after the SiO₂ coating process (FIG. 41-FIG. 42). Cross-sectional SEM was employed to observe the thickness and wetting behavior of the SiO₂ nanoparticles on the LiCoO₂ cathode substrate. In an attempt to disturb the coating as little as possible prior to SEM observation, ion-milling (Hitachi IM4000 Plus) was used for sample preparation allowing for a uniform smooth sample surface to be observed. SiO₂ coated LCO cathodes were punched and transferred into an Ar-filled glovebox (H₂O<0.1 ppm, O₂<0.1 ppm) for cell assembly. 2032-coin cells with coated LiCoO₂ cathodes, 1 M LiClO₄ EC:DMC:FEC (45:45:10) and a graphite anode were assembled to assess the electrochemical performance of the SiO₂ coating as a separator. For comparison, coin cells with non-coated LiCoO₂ electrodes, a polypropylene separator, 1 M LiClO₄ EC:DMC:FEC (45:45:10), and a graphite anode were also assembled. Electrochemical Impedance Spectroscopy (EIS) was performed with a combination Solatron Analytic 1287A potentiostat and a 1260 impedance/gain analyzer with an applied AC range of 10⁶ to 0.1 Hz and a 10 mV amplitude on freshly assembled cells with either an SiO₂ coating or a polypropylene separator to compare the impedance of the SiO₂ to the traditional polymer separator. All full cells were cycled at a low current density of 0.1 mA/cm² for the first two cycles to ensure the formation of a more uniform SEI layer on the graphite anode. After the first two SEI formation cycles, the cells were then cycled at a nominal current density of 1 mA/cm² between 2.8 and 4.2 V vs Li⁺/Li for 50 cycles. Once 50 cycles had passed, the coated LiCoO₂ cathode was washed with diethyl carbonate (DEC) to remove any residual electrolyte salt and dried for further analysis. A LANHE Battery cycler was used for all galvanostatic cycling experiments.

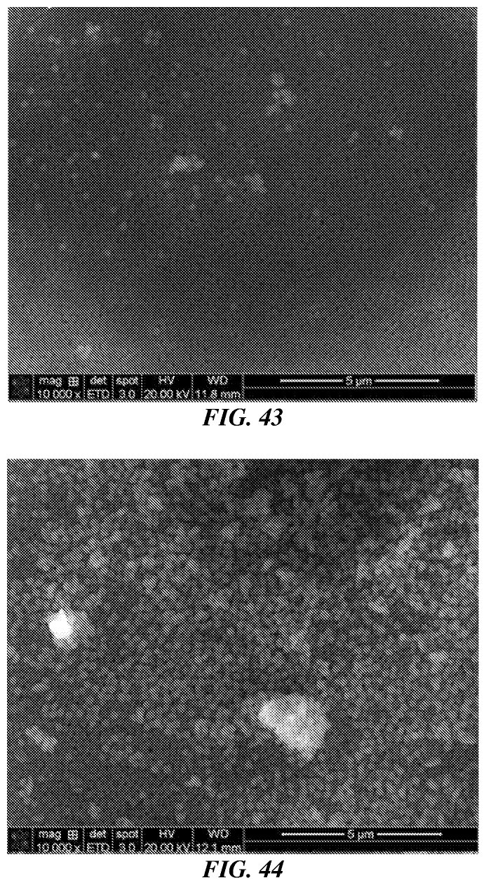

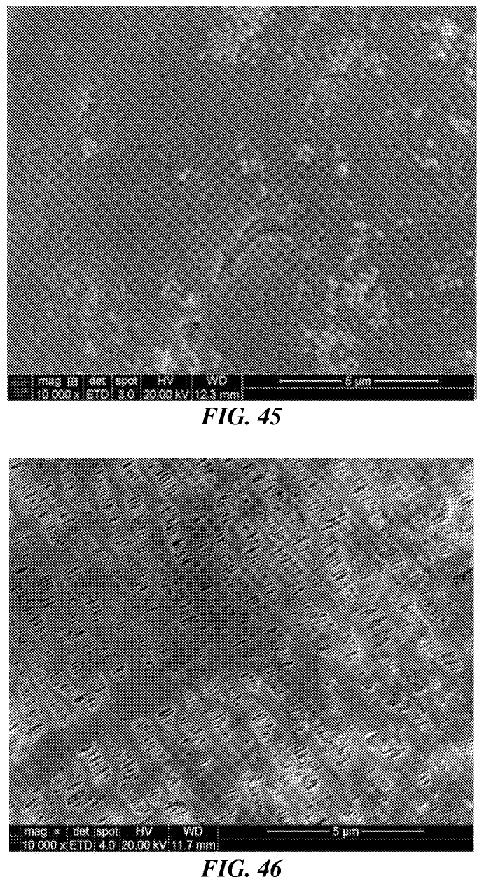

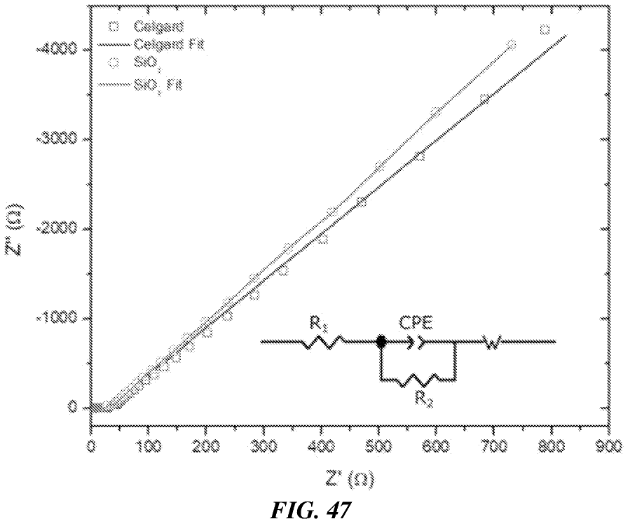

X-ray Photoelectron spectroscopy (XPS) (Kratos Axis Ultra DLD) was used ex-situ to verify bonding states of the silicon and oxygen and whether they changed during the cycling processes of a Li-ion cell. A charge neutralizer was necessary to ensure high resolution spectra could be obtained, since the SiO₂ nanoparticles are strong insulators. Ar-sputtering allowed an XPS depth profile beyond the initial surface of the coating to ensure that surface contamination was removed as well as to ensure the spectra did not significantly change. Depth profiles of elemental distributions were obtained using time-of-flight secondary ion mass spectrometry (TOF-SIMS; ION-TOF GMBH). Bi₃²⁺ ions at an accelerating voltage of 30 kV were used for the analysis and cesium was accelerated at 500 V for sputtering. TOF-SIMS was used to probe the interactions between the LiClO₄ salt and the SiO₂ particles upon cycling. SEM (FEI Quanta 650) was used to observe and compare the shape/morphology of the SiO₂ nanoparticles as prepared, after 24 hours of exposure to 1 M LiClO₄ EC:DMC:FEC (45:45:10), and after 50 charge/discharge cycles (FIG. 43-FIG. 46). Fourier Transform-Infrared Spectroscopy (FTIR) (Infinity Gold FTIR) in attenuated total reflectance (ATR) mode was used to see whether the functionality of the SiO₂ coating changed for any of the samples (FIG. 47). XPS, TOF-SIMS and SEM measurements were conducted without exposing samples to ambient air using air-sensitive transfer techniques.

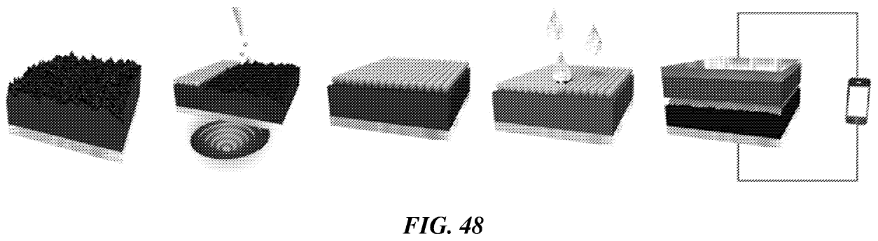

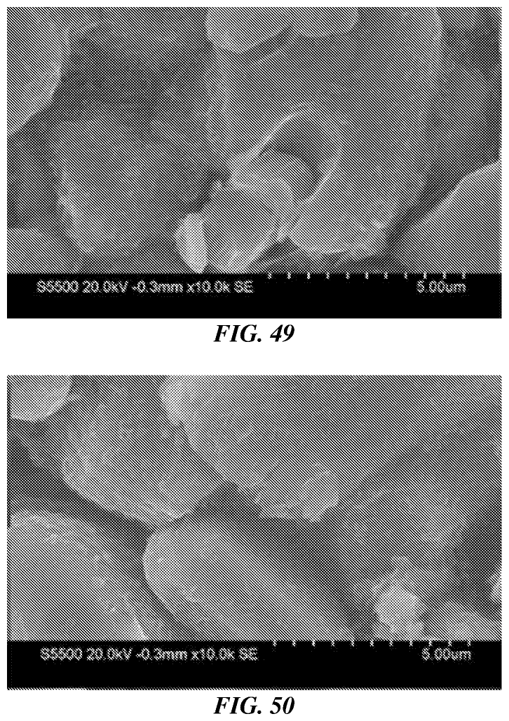

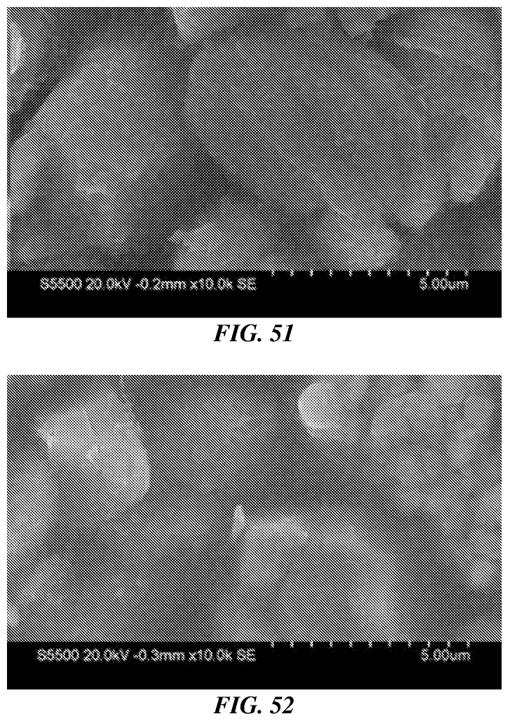

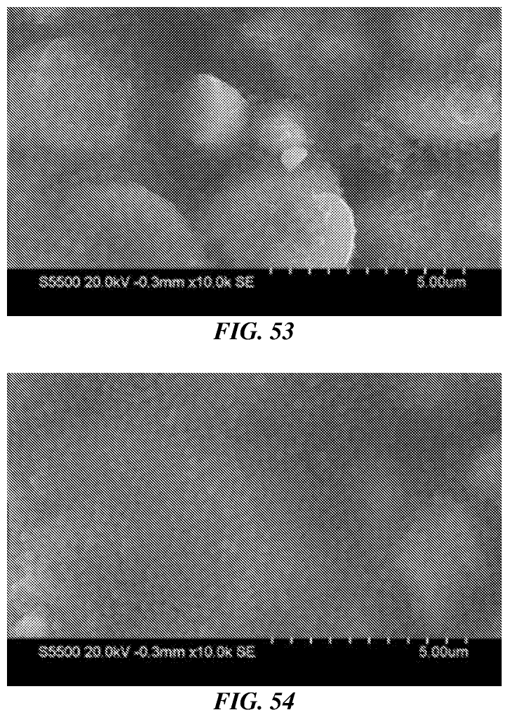

The coating and cell assembly process is illustrated in FIG. 48. Coating of the SiO₂ nanoparticles directly onto the cathode reduces the number of singular components in the cell from four (2 electrodes, a separator, and an electrolyte) to three (1 coated electrode, 1 electrode, and an electrolyte). SEM micrographs of the LCO after various numbers of coatings, FIG. 49-FIG. 54, show the SiO₂ nanoparticle stacking on the cathode matrix. The nanoparticles seem to stack preferentially in the crevices before forming a uniform coating layer by layer. Once the first few SiO₂ particles adhere to the cathode surface, the subsequent coatings begin to aggregate the particles to each other until the crevices are filled in and the surface is flat enough for a uniform deposition to occur. The extreme surface roughness of the cathode matrix should be noted as the cathode particles are still protruding beyond the coating after 20 depositions of the 220 nm SiO₂particles (FIG. 53). After 50 coatings, the cathode particles were no longer visible on the surface of the coated LCO sheet (FIG. 54), giving a coating that would not allow the surface of the cathode to come into contact with the surface of the anode in a full Li-ion cell.

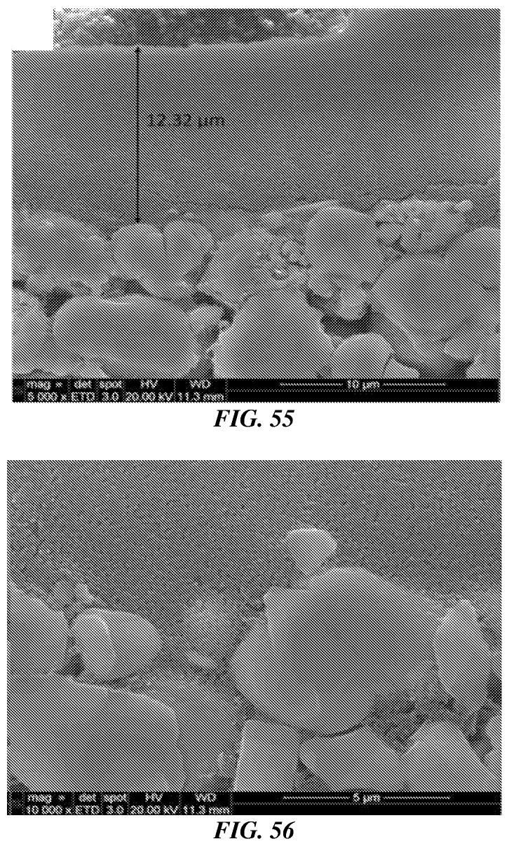

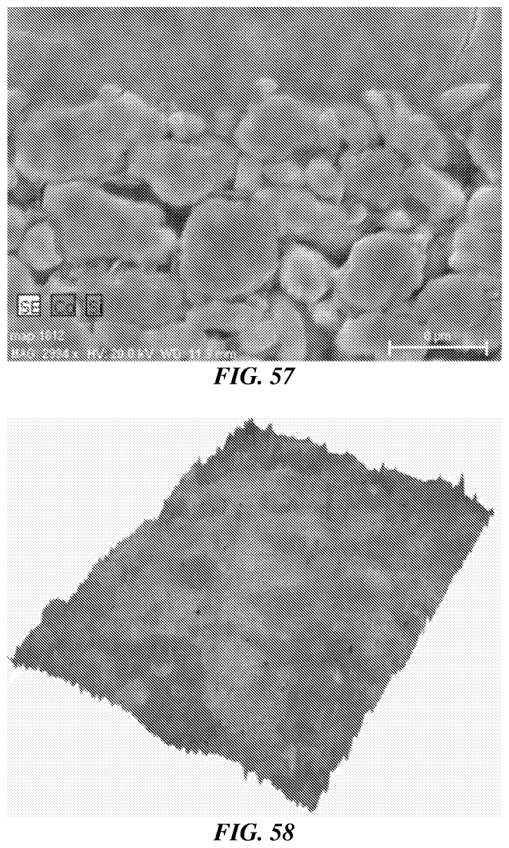

Cross-sectional SEM images of a coated LCO cathode prepared for battery assembly are shown in FIG. 55 and FIG. 56. The total thickness of the SiO₂ nanoparticle separator layer was found to be about 12.3 μm (FIG. 55). This thickness is comparable to the thicknesses of a single-sheet polypropylene separator commonly used in Li-ion batteries (Arora et al. Chemical Reviews 2004, 104(10), 4419-62). The nanoparticles wet the cathode very well, penetrating the cathode matrix and settling between particles in the upper region of the cathode (FIG. 56). Upon exposure to the organic-liquid electrolyte, the sky-blue surface coating (FIG. 40) instantly turned black, indicating good electrolyte wetting of the SiO₂ nanoparticles. The thickness of the SiO₂ separator coating can be tailored to a given application by altering the number of depositions of the particles or the size of the particles themselves, but the final layer should completely cover the electrode. EDS mapping (FIG. 57) shows clear separation between the silicon in the SiO₂ separator layer and the cobalt in the cathode active material. Optical profilometry was used to ensure that there were not inconsistencies in the electrode coating and that the surface of the coated cathode was completely covered with SiO₂ nanoparticles (FIG. 58).

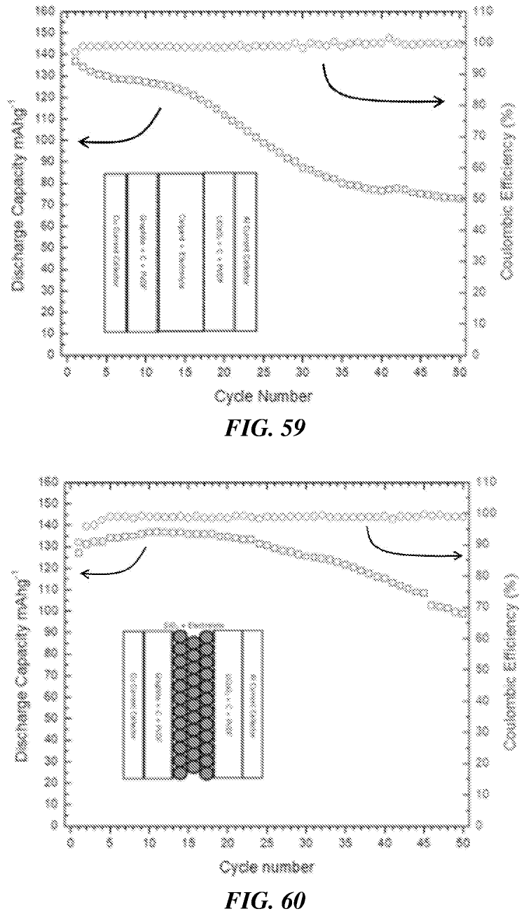

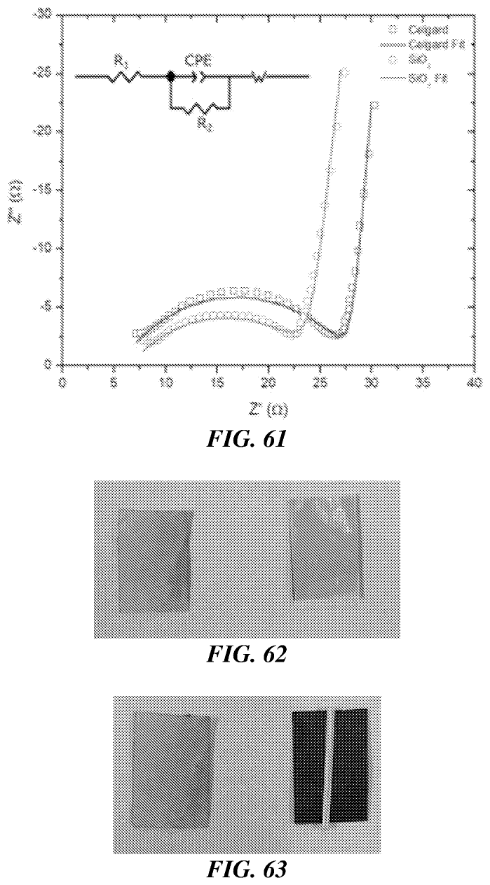

FIG. 59 shows discharge capacity and cycle efficiency for a full LCO against graphite control cell with 1 M LiClO₄ EC:DMC:FEC (45:45:10) and a polypropylene separator. FIG. 60 shows the discharge capacity and cycle efficiency for a similar cell using the SiO₂ nanoparticle coating as a separator instead of polypropylene. Both cells were cycled at a current density of 1 mA/cm², which corresponds roughly to a 1 C rate. The two cells show similar performance for the first 10 cycles, but the control cell shows a much more significant capacity fade after the 10^{th} cycle. Additionally, EIS spectra (FIG. 61) showed a slight decrease in overall cell impedance (R₂) by 6 ohms for a fresh cell with an SiO₂ nanoparticle layer as a separator compared to the cell with a polypropylene separator. The morphology of the SiO₂ nanoparticles just after deposition, after exposure to organic-liquid electrolyte, and after 50 charge/discharge was observed to be stable. The particles did not undergo any significant morphological change after being exposed to electrolyte or after 50 cycles against a graphite anode, keeping their spherical shape. The morphologies of the SiO₂ coating (FIG. 43-FIG. 45) and a polypropylene separator (FIG. 46) used in the cells are significantly different; the nanoparticles show a close-packing on the electrode surface while the polypropylene has nano-sized pores. These pores in a polymer separator membrane shutdown as they approach their melting point starting at 130° C. The small pores in the membrane get covered as the membrane becomes less mechanically rigid at higher temperatures, inhibiting ionic transport through the membrane (USABC “Development of low cost separators for lithium-ion batteries”, RFPI 2001; Laman et al. Ext. Abstr., 6th Int. Meet. Lithium Batteries 1992, 298-300). Silica, with a much higher melting temperature compared to polypropylene (1,710° C. compared to 160° C.), allows for cell operation to higher temperatures without melting the separator, given an electrolyte stable at higher temperatures is used (Kalaga et al. ACS Appl. Mater. Interfaces 2015, 7 (46), 25777-25783). A quick test of thermal stability of the SiO₂ coating and a polypropylene separator was done by putting an SiO₂ coated electrode and an LCO electrode with a piece of polypropylene on it in a furnace at 150° C. for 30 minutes. The SiO₂ remained unaffected by the heat while the polypropylene did not maintain its form (FIG. 62-FIG. 63).

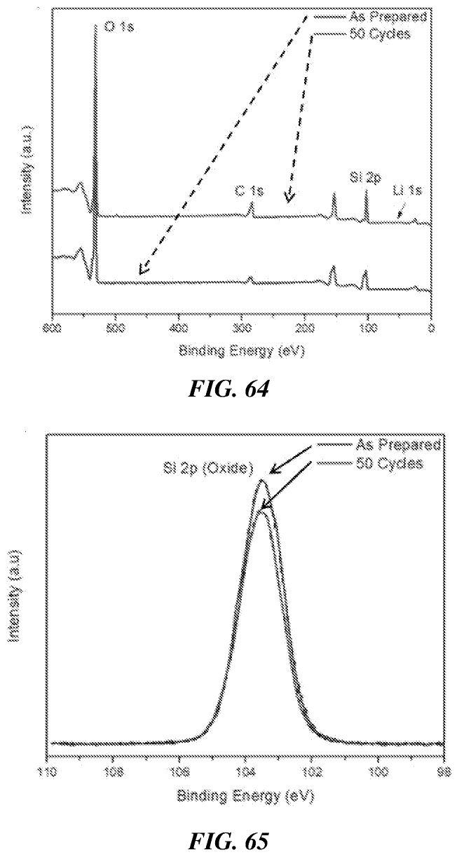

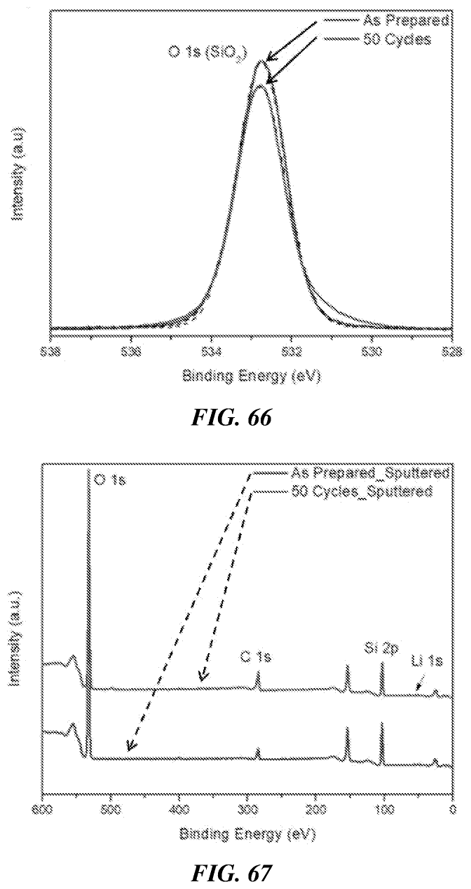

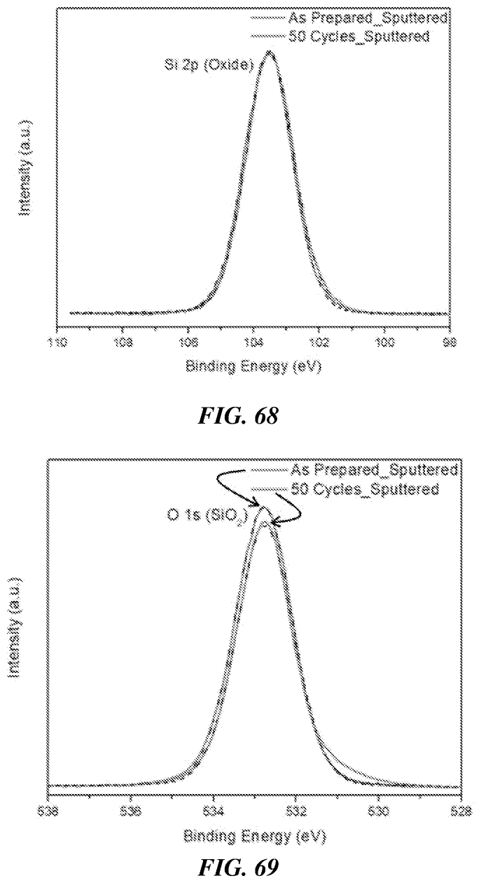

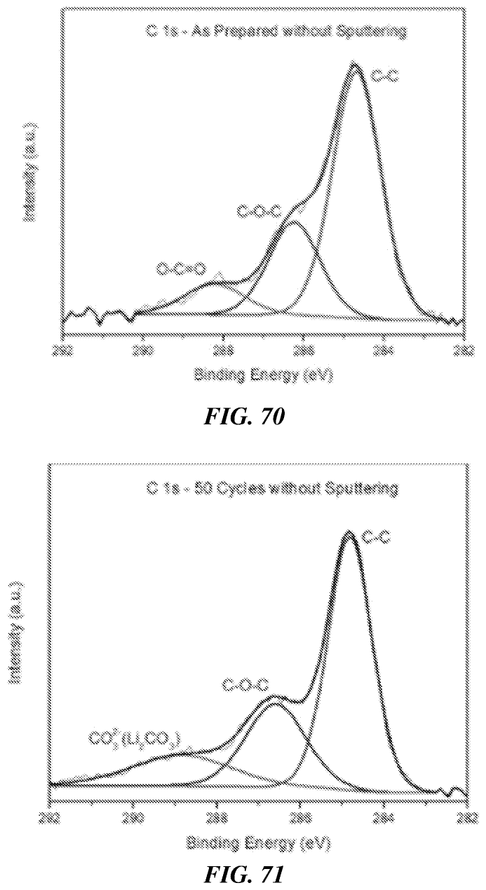

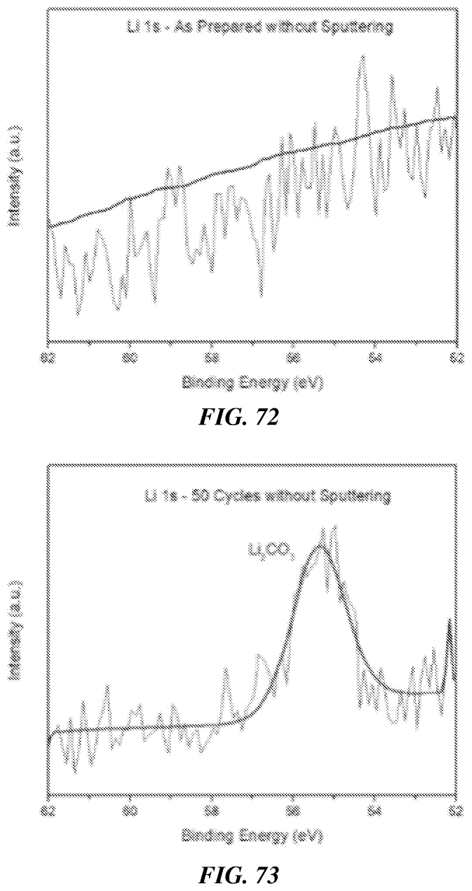

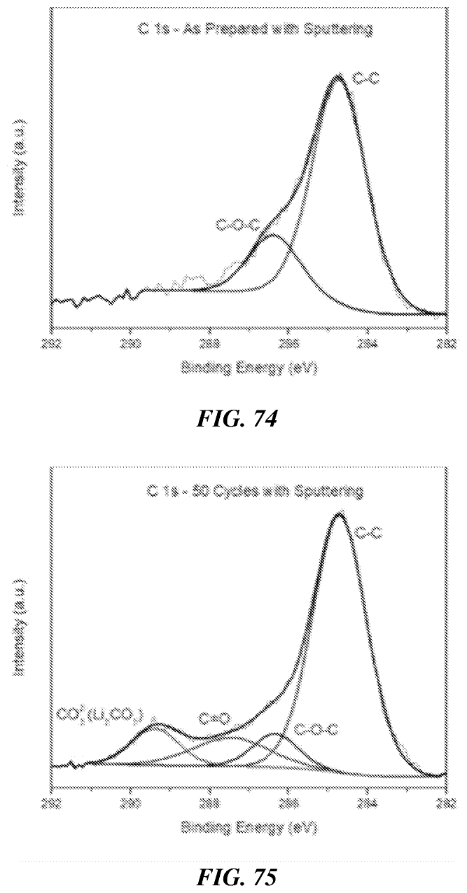

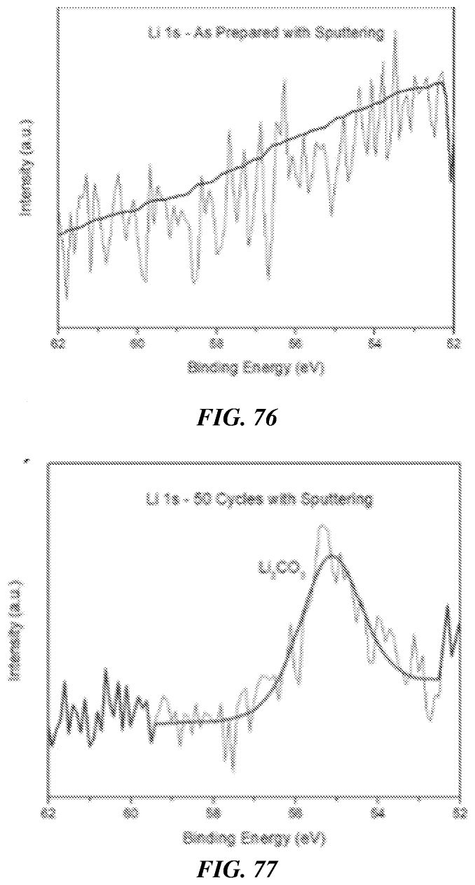

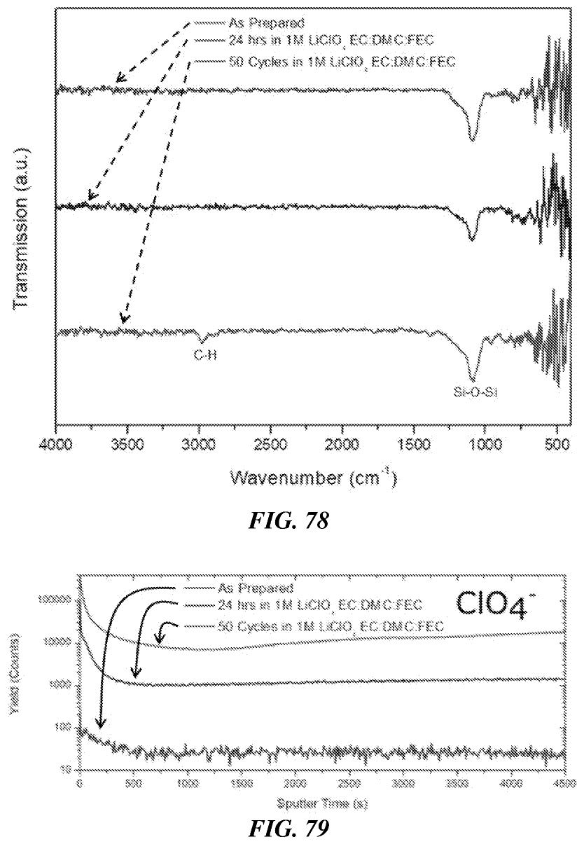

The Si 2p peak of all XPS spectra were normalized to the 103.5 eV binding energy of SiO₂ for analysis. The O 1s peak of each sample was observed after normalization to determine whether the SiO₂ remained inert through each process. Prior to Ar sputtering, the as prepared SiO₂ on a coated electrode and the SiO₂ on a coated electrode that was cycled 50 times showed peaks in the O 1s region that matched each other as well as previously reported values for SiO₂ (FIG. 64-FIG. 66). Each sample was Ar sputtered for 10 s corresponding to a 5 nm depth to remove any surface contamination as well as to probe bonding states further into the bulk of the sample. The O 1s region after sputtering shows that each sample is in excellent agreement with each other as well as with recorded values for the O 1s peak for SiO₂ (FIG. 67-FIG. 69). Overall the XPS results indicate that the bulk of the SiO₂ nanoparticles remained inert when cycled in a battery (FIG. 64-FIG. 77). ATR FTIR of the samples (FIG. 78) showed a characteristic peak at ˜1095 cm⁻¹ owing to the Si—O—Si asymmetric stretch in the SiO₂ molecule for all three samples (Feifel et al. Journal of nanobiotechnology. 2011, 9, 59). Only the cycled sample had an additional peak at 2980 cm⁻¹ corresponding to a C—H bond stretch. This peak can be attributed to residual EC from the electrolyte that did not get fully removed during sample washing. Ultimately, FTIR results indicate that the bulk functionalization of the SiO₂ particles remained the same through exposure to the organic electrolyte and galvanostatic cycling. However, changes in the finger-print region of each FTIR spectra indicated that SiO₂ did undergo some chemical change. Rather than attempt to interpret the finger-print region of the FTIR spectra, ex-situ TOF-SIMS was used to further probe the interactions between the surface of the SiO₂ particles and the LiClO₄ salt from the organic electrolyte during cycling.

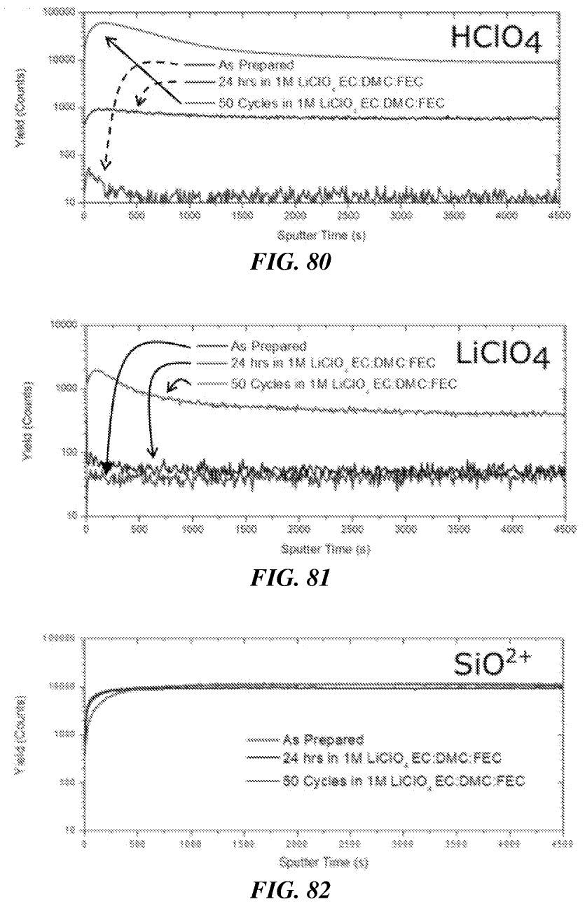

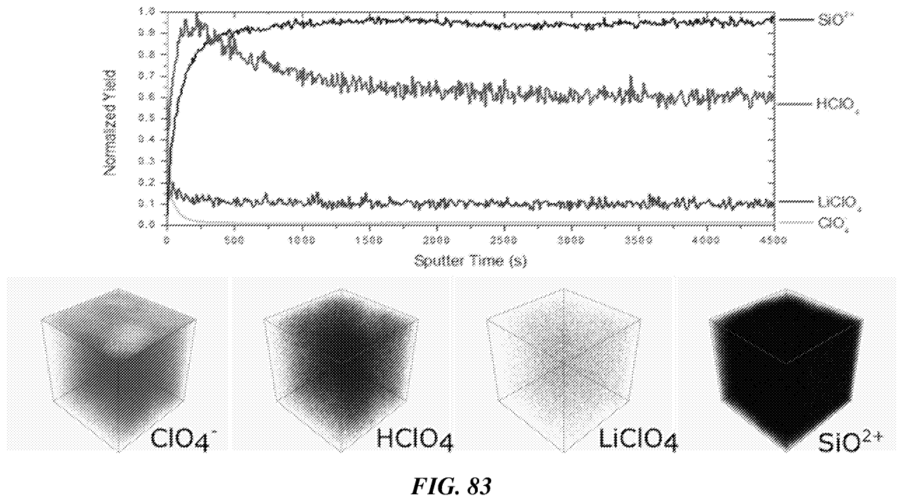

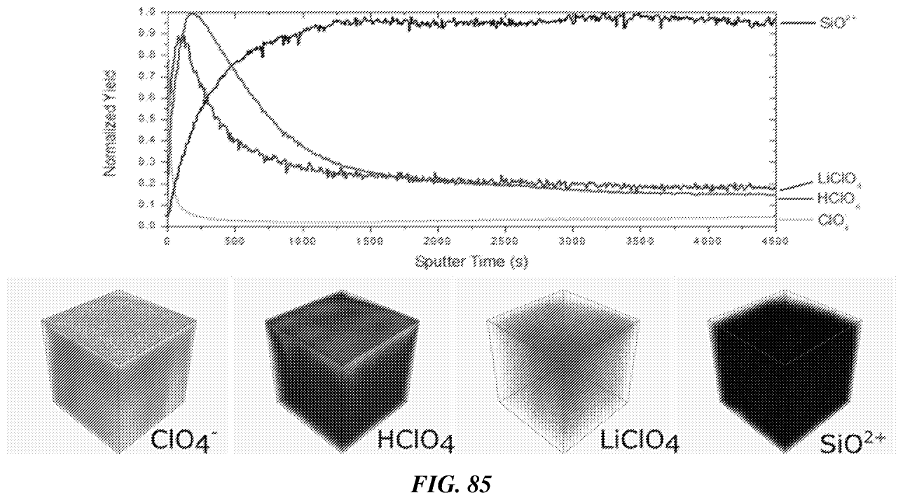

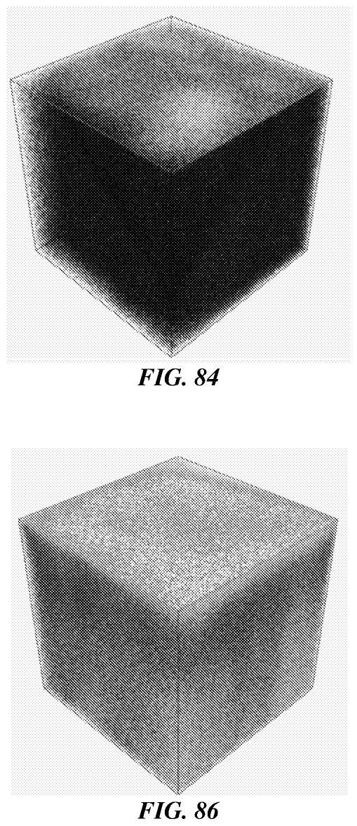

TOF-SIMS allowed observation of the distribution of LiClO₄ salt and related species in a 100 μm×100 μm area on the coated electrode surface; sputtering allowed for a depth profile of selected species. ClO₄⁻, HClO₄, LiClO₄, and SiO⁻ were the species investigated at with depth profiling to see if there was any change in their presence and distribution between an as prepared SiO₂ coated LCO electrode, a coated electrode that had been soaked in organic electrolyte for 24 hours, and a coated electrode that had been cycled for 50 charge/discharge cycles. SiO⁻ was used rather than SiO₂ owing to the large abundance of SiO₂ causing the ion detector to saturate and give a less than ideal depth profile. FIG. 79-FIG. 82 shows TOF-SIMS depth profiles for each species monitored for all three samples. The yield obtained for SiO⁻ for all three samples was similar, but the yield of the three LiClO₄ salt related species were vastly different between each sample. HClO₄ and ClO₄ showed up in the 24 hours-soaked sample, but in far less concentration than in the cycled sample; only trace amounts appeared in the as prepared control sample. LiClO₄ only presented any meaningful yield in the cycled sample, even after thorough washing with DMC, suggesting that battery cycling increases the strength of coordination between the SiO₂ particle surface with the LiClO₄ salt. This is further corroborated by the much larger presence of both ClO₄⁻ and HClO₄ in the cycled sample as opposed to the 24 hours-soaked sample. The flattening of the peak shape of all three salt related species as the samples are sputtered into the bulk indicates that there is a larger presence of these species on the surface of the sample, suggesting that the species are localized to the surface of the SiO₂ particles. FIG. 83-FIG. 86 present a more visual representation of the increased yield of each salt related species in the cycled sample compared to the 24 hours-soaked sample. The normalized depth profile of the 24 hours-soaked sample (FIG. 83) shows that a small amount of HClO₄ and ClO₄⁻ seems to form on the surface of the SiO₂ particles when they are exposed to the 1 M LiClO₄ EC:DMC:FEC (45:45:10), while LiClO₄ hardly coordinate with the particle surface. This is visually represented in the 3D-rendering overlay of all monitored species in FIG. 84. The inability to see any of the salt species through the large concentration of SiO⁻ indicates that the amount of coordinated salt species in very small when compared to the amount that can be seen on the cycled sample (FIG. 86) where all 4 species can be seen in abundance. The normalized depth profile for the cycled sample (FIG. 85) shows a much thicker layer of coordinated salt species designated by the peak-shaped profile that shows up at the beginning of the normalized HClO₄ and LiClO₄ curves as well as the longer sputtering time that it takes for the SiO⁻ species to reach its nominal yield. These observations brought to light by TOF-SIMS show some similarities with the soggy-sand system, but with an increased kinetic stability perhaps stemming from the fixed close-packed structure created by the SiO₂, which are much larger in this instance than those normally reported for soggy-sand electrolytes (Pfaffenhuber et al. Physical Chemistry Chemical Physics 2013, 15(42), 18318-35).

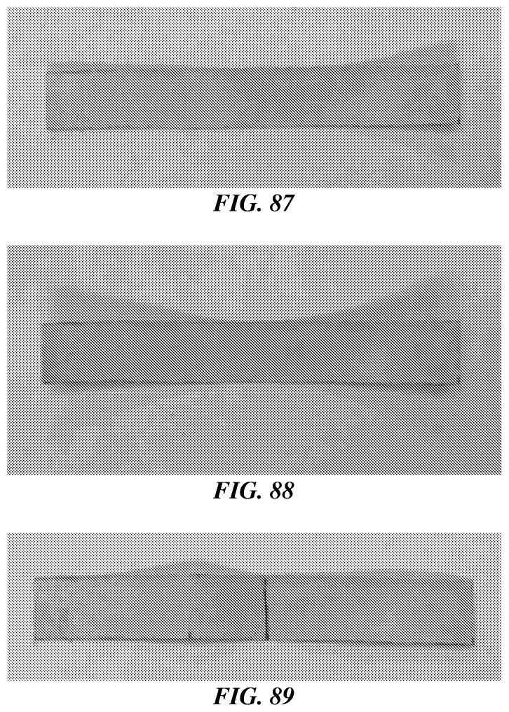

A rudimentary test of the mechanical stability of the SiO₂ coating on the LCO electrode was conducted by rolling the electrode to simulate how it would be treated in a cylindrical cell as well as by folding the coated electrode. Rolling did not affect the SiO₂ coating; however, folding did fracture the coating on the electrode (FIG. 87-FIG. 89). This result gives a positive indication that the SiO₂ will be mechanically robust enough to be used in a cylindrical cell.

SiO₂ has an extensive history as a component of rechargeable-battery separators. With the process of coating an electrode sheet with SiO₂ nanoparticles, the external matrix commonly found in other architectures utilizing nanoparticles has been removed by the self-assembly of the nanoparticles, which is the foundation for an electrode coating. This coating was found to be electrochemically and chemically inactive when exposed to common working conditions associated with rechargeable batteries, ideal traits for a separator material. This coating is inexpensive, easy to produce, and reduces the number of singular components assembled in a battery since the separator is now adhered to one or both electrodes instead of being a standalone component. The coating process for the electrodes has a potential to be implemented easily in current manufacturing plants and to provide larger energy density if the thickness of the coating is optimized for a respective application. Further optimization can also be achieved with different surface functionalization of the nanoparticles. Superior wetting of the SiO₂ particles by the organic-liquid electrolyte can allow for a reduced amount of the flammable electrolyte to be used in larger format cells, such as pouch cells.

Wetting of the SiO₂ particles by metallic lithium and the small pores of the nanoparticle SiO₂ layer can also inhibit formation and growth of anode dendrites from a lithium layer plated on a carbon anode during a fast-charge. Additionally, the interaction between the SiO₂ particle surface and the salt within the liquid electrolyte can lead to a higher Li⁺ transference number as in the soggy-sand electrolyte system.

### Example 3

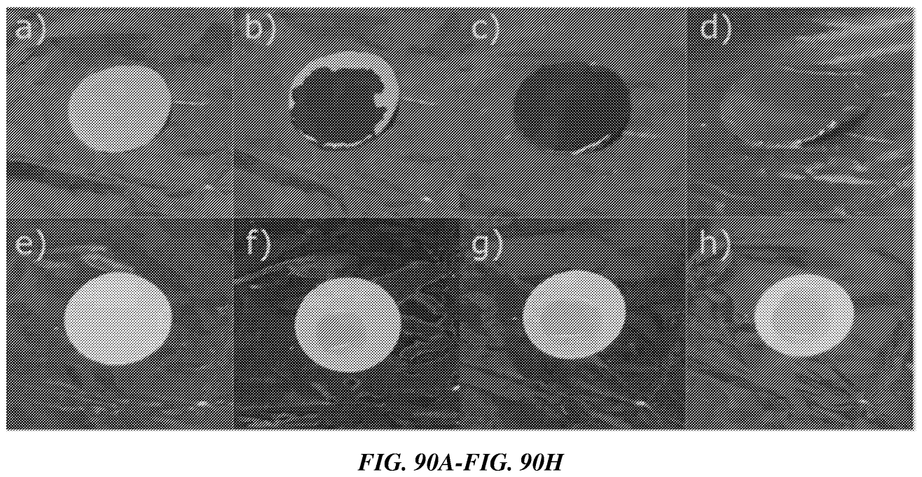

Described herein are coated electrodes comprising a first electrode and a porous separator layer, wherein the porous separator layer comprises a plurality of electrically insulating particles and a plurality of pores, wherein the porous separator layer is coated on the first electrode. In some examples, the coated electrodes can exhibit superior wettability compared to traditional polymer separators, such as polypropylene separators. A wetting experiment for an LCO electrode coated with SiO₂ particles, as described herein, compared to a traditional polypropylene separator is shown in FIG. 90A-FIG. 90F.

FIG. 90A is a photograph of the as prepared SiO₂ coated LCO electrode. FIG. 90B is a photograph of the SiO₂ coated LCO electrode immediately after 1 drop (40 μL) of electrolyte was added to the SiO₂ coated LCO electrode. FIG. 90C and FIG. 90D are photographs of the SiO₂ coated LCO electrode after the 1 drop of electrolyte has been left for about 10 seconds on the SiO₂ coated LCO electrode, showing complete wetting of the SiO₂ layer by the electrolyte.

FIG. 90E is a photograph of a polypropylene separator. FIG. 90F, FIG. 90G, and FIG. 90H are photographs of the polypropylene separator immediately after 1 drop (40 μL) of electrolyte was added, immediately after 2 drops (80 μL) of electrolyte were added, and immediately after 3 drops (120 μL) of electrolyte were added, showing that the polypropylene even after 3 drops of electrolyte were added is not completely wetted by the electrolyte.

The composition of the plurality of electrically insulating particles, the geometry (size, shape, combinations thereof, etc.) of the plurality of electrically insulating particles, the geometry of the layer of insulating particles (e.g., thickness, packing density, porosity), etc. can, for example, be selected to adjust the wettability of the coated electrodes described herein. In some examples the plurality of electrically insulating particles can be further functionalized to adjust the wettability of the coated electrodes described herein.

The devices and methods of the appended claims are not limited in scope by the specific devices and methods described herein, which are intended as illustrations of a few aspects of the claims and any devices and methods that are functionally equivalent are within the scope of this disclosure. Various modifications of the devices and methods in addition to those shown and described herein are intended to fall within the scope of the appended claims. Further, while only certain representative devices and methods, and aspects of these devices and methods are specifically described, other devices and methods and combinations of various features of the devices and methods are intended to fall within the scope of the appended claims, even if not specifically recited. Thus, a combination of steps, elements, components, or constituents can be explicitly mentioned herein; however, all other combinations of steps, elements, components, and constituents are included, even though not explicitly stated.

1. An electrochemical device comprising:
a coated electrode comprising a first electrode and a porous separator layer, wherein the porous separator layer comprises a plurality of electrically insulating particles and a plurality of pores, wherein the porous separator layer is coated on the first electrode;
a second electrode; and
an electrolyte;
wherein the coated electrode is in contact with the second electrode such that the porous separator layer is disposed between the first electrode and the second electrode and the porous separator layer is in contact with the first electrode and the second electrode, thereby forming an electrode assembly; and
wherein the electrolyte is in electrochemical contact with the first electrode and the second electrode.

2. (canceled)

3. The electrochemical device of claim 1, wherein the plurality of electrically insulating particles comprise Al₂O₃, SiO₂, BeO, Si₂O₃, Ga₂O₃, HfO₂, MgO, MoO₃, Sc₂O₃, Ta₂O₅, ZrO₂, Si₃N₄, AlN, BN, graphitic carbon nitride, P₃N₅, SiC, CaC₂, BaTiO₃, Ba(Sr)TiO₃, Ba(Pb)TiO₃, PbTiO₃, PbZnO₃, Pb(Zn,Ti)O₃, Pb(La)TiO₃, Pb(La)Zn(Ti)O₃, SrTiO₃, LiNbO₃, LiTaO₃, Pb(Mg, Nb)O₃, Pb(Mg,Nb)O₃:PbTiO₃, B₄Ti₃O₁₂, BaFe₁₂O₁₉, or combinations thereof.

4. The electrochemical device of claim 1, wherein the plurality of electrically insulating particles comprise glass, quartz, porcelain, ceramic, kaolin, mica, steatite, sapphire, slate, or combinations thereof.

5. The electrochemical device of claim 1, wherein the plurality of electrically insulating particles comprise an electrically insulating polymer.

6. (canceled)

7. The electrochemical device of claim 1, wherein the plurality of electrically insulating particles are substantially spherical in shape.

8. The electrochemical device of claim 1, wherein the plurality of electrically insulating particles have an average particle size of from 50 picometers (pm) to 10 millimeters (mm).

9. (canceled)

10. The electrochemical device of claim 1, wherein the plurality of electrically insulating particles have a packing density of from 50% to 100% in the porous separator layer.

11. The electrochemical device of claim 1, wherein the plurality of electrically insulating particles are functionalized.

12. (canceled)

13. (canceled)

14. The electrochemical device of claim 1, wherein the plurality of electrically insulating particles comprise a plurality of porous particles.

15. The electrochemical device of claim 1, wherein the porous separator layer has an average thickness of from 1 nm to 100 mm.

16. The electrochemical device of claim 1, wherein the first electrode and/or the second electrode independently comprise(s) an active material, a transparent conducting oxide, a metal oxide, a conducting polymer, a carbon material, a metal, or a combination thereof.

17. (canceled)

18. (canceled)

19. (canceled)

20. (canceled)

21. (canceled)

22. (canceled)

23. The electrochemical device of claim 1, wherein the electrode assembly has an average thickness of from 3 nm to 250 mm.

24. The electrochemical device of claim 1, wherein the electrolyte comprises a liquid electrolyte.

25. (canceled)

26. The electrochemical device of claim 24, wherein the liquid electrolyte comprises a solvent with a dissolved ion source.

27. (canceled)

28. (canceled)

29. (canceled)

30. (canceled)

31. The electrochemical device of claim 24, wherein at least a portion of the plurality of electrically insulating particles are functionalized by the liquid electrolyte or a derivative thereof.

32. (canceled)

33. (canceled)

34. (canceled)

35. (canceled)

36. The electrochemical device of claim 1, wherein the electrolyte comprises a solid electrolyte, wherein the solid electrolyte is formed in situ from a liquid precursor in contact with the electrode assembly.

37. The electrochemical device of claim 1, wherein the porous separator layer consists essentially of the plurality of electrically insulating particles and the plurality of pores.

38. (canceled)

39. (canceled)

40. (canceled)

41. (canceled)

42. (canceled)

43. (canceled)

44. (canceled)

45. The electrochemical device of claim 1, wherein the electrochemical device comprises a stacked electrode assembly comprising a plurality of the coated electrodes and a plurality of the second electrodes, the plurality of coated electrodes and the plurality of second electrodes being alternately stacked with the porous separator layer interposed between each of the plurality of coated electrodes and the plurality of second electrodes.

46. The electrochemical device of claim 1, wherein the electrochemical device comprises a battery.

47. A method of making the electrochemical device of claim 1, the method comprising:
dispersing the plurality of electrically insulating particles in a solvent, thereby forming a mixture;
depositing the mixture on the first electrode, thereby coating the porous separator layer on the first electrode and forming the coated electrode; and
sandwiching the porous separator layer between the first electrode and the second electrode, thereby forming an electrode assembly; and
contacting the electrode assembly with the electrolyte, thereby forming the electrochemical device.

48. (canceled)

49. (canceled)

50. (canceled)
